(19) United States
(12) Patent Application Publication
(10) Pub. No.: US 2014/0333422 A1
(43) Pub. Date: Nov. 13, 2014

(54) DISPLAY APPARATUS AND METHOD OF PROVIDING A USER INTERFACE THEREOF

(71) Applicant: SAMSUNG ELECTRONICS CO., LTD., Suwon-si (KR)

(72) Inventors: Joon-ho PHANG, Seoul (KR); Joo-sun MOON, Seoul (KR); Hong-pyo KIM, Goyang-si (KR); Yi-sak PARK, Seoul (KR); Christopher E. BANGLE, Clavesana (IT)

(73) Assignee: SAMSUNG ELECTRONICS CO., LTD., Suwon-si (KR)

(21) Appl. No.: 14/275,440

(22) Filed: May 12, 2014

(30) Foreign Application Priority Data
May 10, 2013 (KR) 10-2013-0053433

(51) Int. Cl. G08C 17/02

(52) U.S. Cl. CPC G08C 17/02; G08C 2201/30
USPC 340/12.54

(57) ABSTRACT

A display apparatus and a UI providing method are disclosed. The display apparatus includes a display configured to display a plurality of screens on a first area of a display screen and a plurality of objects categorized into a plurality of groups on a second area of the display screen, a user interface configured to detect a user interaction, and a controller configured to control the display to reproduce a content which corresponds to the selected object according to the predetermined user interaction on one of the plurality of screens in response to a predetermined user interaction being detected through a user interface while one object is selected among the plurality of objects.

### CROSS-REFERENCE TO RELATED APPLICATIONS

This application claims priority from Korean Patent Application No. 10-2013-0053433, filed on May 10, 2013 in the Korean Intellectual Property Office, the disclosure of which is incorporated herein by reference, in its entirety.

### BACKGROUND

1. Technical Field

Devices and methods consistent with the exemplary embodiments relate to a display apparatus and a method of providing a user interface thereof. More specifically, the exemplary embodiments relate to a display apparatus configured to display a plurality of screens on one display screen and select contents to be respectively displayed on the plurality of screens, and a method for providing a UI thereof.

2. Description of the Related Art

As contents increase and user needs expand, related display apparatuses are required to receive contents from various sources and provide various contents to users. While the amount of contents provided to related display apparatuses increases, there is a demand that the display apparatuses provide a plurality of screens in order to allow a user to search contents that he or she is trying to view among numerous contents. For example, related display apparatuses provide additional screens such as main screen and a PIP screen for the plurality of screens.

However, the related display apparatuses select contents to be displayed on the plurality of screens by using a separate UI such as an EPG screen in order to select contents to be displayed on the plurality of screens.

Thus, by displaying a separate UI to select contents to be displayed on the plurality of screens, in accordance with the related methods, a user cannot confirm contents to be displayed on the plurality of screens while displaying a separate UI, and may need additional motion such as screen converting motion to confirm the contents to be displayed on the plurality of screens.

Therefore, a new method is needed for more intuitively and more easily selecting the contents to be displayed on the plurality of screens.

### SUMMARY

An aspect of the exemplary embodiments is proposed to provide a display apparatus which enables a user to more intuitively and more easily select contents to be displayed on a plurality of screens included in a display screen and a control method thereof.

A display apparatus according to an exemplary embodiment includes a display configured to display a plurality of screens on a first area of a display screen and display a plurality of objects categorized into a plurality of groups on a second area of the display screen; a user interface configured to detect a user interaction; and a controller configured to, when a predetermined user interaction is detected through the user interface while one of the plurality of objects is selected, control the display to reproduce a content corresponding to the selected object on one of the plurality of screens in accordance with the predetermined user interaction.

The display may display a main screen on a first area of the display screen and a first sub-screen and a second sub-screen in a trapezoid form on an left side and a right side of the main screen.

When a predetermined user interaction is detected while a highlight is displayed on one of the plurality of objects, the controller may control the display to reproduce a content corresponding to an object where the highlight is displayed on one of the plurality of screens in accordance with the predetermined user interaction.

When the predetermined user interaction is a user interaction to select one of a first to a third buttons corresponding to the main screen, the first sub-screen, and the second sub-screen on a remote controller respectively, if a user interaction to select one of the first to the third buttons is input while a highlight is displayed on one of the plurality of objects, the controller may control the display to reproduce a content corresponding to an object where the highlight is displayed on a screen corresponding to the selected button.

The first to the third button on a remote controller may correspond to shapes of the main screen, the first sub-screen, and the second sub-screen, respectively. The display may display a plurality of objects displayed on a second area of the display screen on different spaces according to a group, wherein each of the plurality of objects is in a cubic form.

When a predetermined first user interaction is input through the user interface, the controller may control the display to remove the plurality of objects displayed on a second area of the display screen from the display screen, and expand and display the plurality of screens displayed on a first area of the display screen.

When a predetermined second user interaction is input through the user interface while the plurality of screens are expanded and displayed, the controller may reduce a size of the main screen from among the plurality of screens, and display a plurality of thumbnail screens corresponding to a plurality of contents in a predetermined direction with reference to the reduced main screen, wherein when one of thumbnail screens corresponding to the plurality of contents is selected, the controller may control the display to reproduce a content corresponding to the selected thumbnail screen on the main screen.

When a predetermined third user interaction is input through the user interface, the controller may control the display remove the plurality of screens displayed on a first area of the display screen from the display screen, and expand and display the plurality of objects displayed on a second area of the display screen.

When one of a first to a third buttons corresponding to the main screen, the first sub-screen, and the second sub-screen on a remote controller respectively is selected while one of the expanded plurality of objects is selected, the controller may control the display to remove the expanded plurality of objects from a display screen, display the display screen on the plurality of screens, and reproduce a content corresponding to the selected object on a screen corresponding to the selected button.

A UI providing method in a display apparatus includes displaying a plurality of screens on a first area of a display screen and displaying a plurality of objects categorized into a plurality of groups on a second area of the display screen; and when a predetermined user interaction is detected through the user interface while one of the plurality of objects is selected, reproducing a content corresponding to the selected object on one of the plurality of screens in accordance with the predetermined user interaction.

The displaying may include displaying a main screen on a first area of the display screen and a first sub-screen and a second sub-screen in a trapezoid form on a left side and a right side of the main screen.

The reproducing may include, when a predetermined user interaction is detected while a highlight is displayed on one of the plurality of objects, reproducing a content corresponding to an object where the highlight is displayed on one of the plurality of screens in accordance with the predetermined user interaction.

The reproducing may include, when the predetermined user interaction is a user interaction to select one of a first to a third buttons corresponding to the main screen, the first sub-screen, and the second sub-screen on a remote controller respectively, if a user interaction to select one of the first to the third buttons is input while a highlight is displayed on one of the plurality of objects, reproducing a content corresponding to an object where the highlight is displayed on a screen corresponding to the selected button.

The first to the third button on a remote controller may correspond to shapes of the main screen, the first sub-screen, and the second sub-screen, respectively.

The displaying may include displaying a plurality of objects displayed on a second area of the display screen on different spaces according to a group, wherein each of the plurality of objects is in a cubic form.

The method may include, when a predetermined first user interaction is input through the user interface, removing the plurality of objects displayed on a second area of the display screen from the display screen, and expanding and displaying the plurality of screens displayed on a first area of the display screen.

The method may include, when a predetermined second user interaction is input through the user interface while the plurality of screens are expanded and displayed, reducing a size of the main screen from among the plurality of screens, and displaying a plurality of thumbnail screens corresponding to a plurality of contents in a predetermined direction with reference to the reduced main screen; and when one of thumbnail screens corresponding to the plurality of contents is selected, reproducing a content corresponding to the selected thumbnail screen on the main screen.

The method may include, when a predetermined third user interaction is input through the user interface, removing the plurality of screens displayed on a first area of the display screen from the display screen, and expanding and displaying the plurality of objects displayed on a second area of the display screen. The method may include, when one of a first to a third buttons corresponding to the main screen, the first sub-screen, and the second sub-screen on a remote controller respectively is selected while one of the expanded plurality of objects is selected, removing the expanded plurality of objects from a display screen, displaying the display screen on the plurality of screens, and reproducing a content corresponding to the selected object on a screen corresponding to the selected button.

An aspect of an exemplary embodiment may provide a display apparatus, the display apparatus including: a display configured to display a plurality of screens on a first area of a display screen and display a plurality of objects categorized into a plurality of groups on a second area of the display screen; wherein the display is configured to display a main screen on the first area of the display screen and a first sub-screen and a second sub-screen in trapezoidal form on a left side and a right side of the main screen on the second area; a user interface configured to detect a predetermined user interaction; and a controller configured to control the display to reproduce a content which corresponds to a selected object on one of the plurality of screens in response to the predetermined user interaction being detected through the user interface while one of the plurality of objects is being selected.

The display may be configured to display a plurality of objects displayed on the second area of the display screen on different spaces according to a group, wherein each of the plurality of objects is in a cubic form.

The objects in cubic form include a length, width and depth that is adjusted by the controller in response to a detected user interaction.

In response to a predetermined first user interaction being input through the user interface, the controller may be configured to control the display to remove from the display screen the plurality of objects displayed on a second area of the display screen, and expand and display the plurality of screens displayed on a first area of the display screen.

The controller may be configured to reduce a size of the main screen from among the plurality of screens, and display a plurality of thumbnail screens which correspond to a plurality of contents in a predetermined direction with reference to the reduced main screen, in response to a predetermined second user interaction being input through the user interface while the plurality of screens are expanded and displayed,

The controller may be configured to control the display to reproduce a content which corresponds to the selected thumbnail screen on the main screen in response to one of thumbnail screens which corresponds to the plurality of contents being selected.

The display apparatus may further include a remote controller, wherein the predetermined user interaction is a user interaction to select one of a first to a third button on the remote controller.

An aspect of an exemplary embodiment may provide a display apparatus, including: a display having a display screen; configured to display a plurality of screens on a first area of a display screen and display a plurality of objects categorized into a plurality of groups on a second area of the display screen; a user interface configured to detect a predetermined user interaction; and a controller configured to, display a plurality of screens on a first area of the display screen of the display and display a plurality of objects categorized into a plurality of groups on a second area of the display screen; control the display to reproduce a content which corresponds to a selected object on one of the plurality of screens when in response to a the predetermined user interaction is being detected through the user interface while one of the plurality of objects is being selected, control the display to reproduce a content corresponding to the selected object on one of the plurality of screens in accordance with the predetermined user interaction.

A further aspect of an exemplary embodiment may provide a UI providing method in a display apparatus, the method including: displaying a plurality of screens on a first area of a display screen and displaying a plurality of objects categorized into a plurality of groups on a second area of the display screen; and reproducing a content which corresponds to a selected object on one of the plurality of screens when in response to a predetermined user interaction is being detected through the user interface while one of the plurality of objects is selected by the user, reproducing a content corresponding to the selected object on one of the plurality of screens in accordance with the predetermined user interaction.

### BRIEF DESCRIPTION OF THE DRAWINGS

The above and/or other aspects will be more apparent by describing certain exemplary embodiments with reference to the accompanying drawings, in which:

FIG. 1 illustrates a display system according to an exemplary embodiment;

FIG. 2 is a block diagram which briefly illustrates the constitution of a display apparatus according to an exemplary embodiment;

FIG. 3 is a detailed block diagram of a display apparatus according to an exemplary embodiment;

FIG. 4 is a detailed block diagram of a storage according to an exemplary embodiment;

FIGS. 5 to 22 are views provided to explain a method of controlling a plurality of screens according to various exemplary embodiments;

FIGS. 23 and 24 are flowcharts provided to explain a method of controlling a plurality of screens according to various exemplary embodiments; and

FIG. 25 is a view provided to explain a method for detecting a shaking motion of a user's head according to an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Accordingly, it is apparent that the exemplary embodiments can be carried out without those specifically defined matters. Also, well-known functions or constructions are not described in detail since they would obscure the invention with unnecessary detail.

Referring to the attached drawings, the invention will be described in detail below.

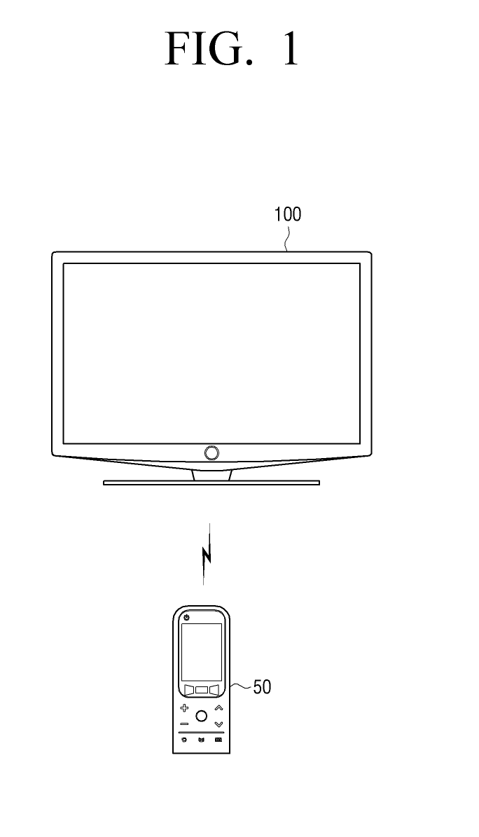

FIG. 1 is a view which is provided to explain a display system according to an exemplary embodiment. Referring to FIG. 1, the display system 10 according to an exemplary embodiment includes a display apparatus 100 and a remote controller 50.

The display apparatus 100 may be implemented as digital TV, illustrated in FIG. 1, but is not limited thereto. Accordingly, the display apparatus 100 may be implemented as various types of devices provided with a displaying function, such as, for example, PC, mobile phone, tablet PC, smart phone, PMP, PDA, or GPS. In response to the display apparatus 100 being implemented to be a mobile device, the display apparatus 100 may include a touch screen therein so that programs are executed with a finger or a pen (e.g., stylus pen). However, for convenience of explanation, the following will be assumed and explain a case which the display apparatus 100 is implemented to be a digital TV.

In response to the display apparatus 100 being implemented as a digital TV, the display apparatus 100 may be controlled by a remote controller 50. In one exemplary embodiment, the remote controller 50 may be configured to control the display apparatus 100 remotely, receive a user interaction, and transmit control signals which correspond to the user inputted interaction to the display apparatus 100. For example, the remote controller 50 may be implemented in various forms that, for example, detects motion of the remote controller 50 and transmits corresponding signals to the motion, recognizes voices and transmits corresponding signals to the recognized voices, or transmits corresponding signals to an inputted key.

Specifically, the display apparatus 100 may display a plurality of screens to reproduce a plurality of contents, and a plurality of objects categorized into a plurality of groups on one display screen according to a user interaction. Further, the display apparatus 100 may select contents to be displayed on the plurality of screens by selecting one object among the plurality of objects. In the following, various exemplary embodiments will be explained by referring to a block diagram which describes g detailed constitution of the display apparatus 100.

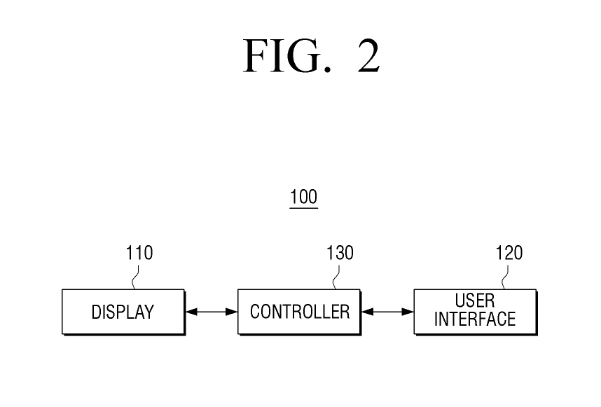

FIG. 2 is a block diagram of a display apparatus according to an exemplary embodiment.

Referring to FIG. 2, the display apparatus 100 includes a display 110, a user interface 120 and a controller 130.

The display 110 outputs image data or a UI which are received externally or previously stored by controlling of the controller 130. Specifically, the display 110 may display a plurality of screens on a first area of the display screen, according to a predetermined command and display a plurality of objects categorized into a plurality of groups on a second area of the display screen. Specifically, the display 110 may display a main screen on a center of the upper area on the display screen, and display a first sub-screen and a second sub-screen on a left side and a right side of the main screen. Further, the display 110 may display a plurality of objects in a trapezoid form to be displayed on a predetermined area according to the categorized groups on the lower area of the display screen.

The plurality of objects may be cubic; in this case, corresponding objects are named as cubic GUI. However, this is merely one of a plurality of exemplary embodiments. Objects may be formed in dimensional shapes such as a triangular prism, a hexagonal prism, a hexahedron, and a sphere. Further, in plane shapes such as a quadrangle, a circle and a triangle.

Meanwhile, the display 110 may be implemented to be liquid crystal display panel (LCD) or organic light emitting diodes (OLED), although the type of display is not limited thereto. Further, the display 110 may be implemented to be a flexible display or a transparent display in cases.

The user interface 120 detects various user interactions. Specifically, the user interface 120 may detect a user interaction to select one object among the plurality of objects and a user interaction to select a screen displaying a corresponding content which corresponds to the selected object.

Herein, the user interface 120 may be implemented in various forms according to implementing exemplary embodiments of the display apparatus 100. In response to the display apparatus 100 being implemented to be digital TV, the user interface 120 may be implemented to be a remote controlling receiver which receives remote controller signals, a camera detecting user motion, and microphone receiving user voices. Further, in response to the display apparatus 100 being implemented to be mobile terminal based on touch, the user interface 120 may be implemented to be touch screen that forms an interlayer structure with a touch pad. In this case, the user interface 120 may be used as a display 110, which is described above.

The controller 130 controls overall operations regarding the display apparatus 100. Specifically, in response to a predetermined user interaction being detected through the user interface 120 while one object is selected among the plurality of objects displayed on the display 110, the controller 130 may control the display 110 to reproduce a content which corresponds to the selected object on one of the plurality of screens, according to a predetermined user interaction.

Specifically, in response to a predetermined user interaction being detected through the user interface 120 while a highlight is displayed on one object among the plurality of objects displayed on the display 110, the controller 130 may control the display 110 to reproduce a corresponding content to the object marked with a highlight on one screen which corresponds to the predetermined user interaction among the plurality of screens.

According to an exemplary embodiment, in response to a predetermined user interaction being a user interaction to select one of a first to a third buttons that are provided on the remote controller respectively corresponding to a main screen, a first sub-screen and a second sub-screen, in response to a user interaction to select one among the first to third buttons being inputted while displaying a highlight on one from a plurality of cubic GUIs, the controller 130 may control the display 110 to reproduce a content which corresponds to a cubic GUI marked with a highlight on a screen corresponding to the selected button among the plurality of screens. For example, in response to a user interaction to select the first button being inputted while displaying a highlight on a first cubic GUI which corresponds to a first broadcasting channel, the controller 130 may control the display 110 to display a broadcast content of the first broadcast channel among the plurality of cubic GUIs which correspond to the first cubic GUI on the main screen which corresponds to the first button. In response to a user interaction to select the second button being inputted while displaying a highlight on a second cubic GUI which corresponds to a second broadcast channel among the plurality of cubic GUIs, the controller 130 may control the display 110 to display a broadcast content of the second broadcast channel which corresponds to the second cubic GUI on the first sub-screen which corresponds to the second button. In response to a user interaction to select the third button being inputted while displaying a highlight on a third cubic GUI which corresponds to a first SNS content among the plurality of cubic GUIs, the controller 130 may control the display 110 to display SNS content which corresponds to the third cubic GUI on the second sub-screen which corresponds to the third button.

The above exemplary embodiment explains that the predetermined buttons provided on the remote controller are used to select a screen which displays a content corresponding to the selected cubic GUI; however, this is merely one of various exemplary embodiments. A screen displaying a content may be selected by using another method. For example, a user may select a screen which displays a content corresponding to the selected cubic GUI by using a voice command. Specifically, in response to a user voice heard as “main” being inputted through a microphone (not illustrated) in the user interface 120 while displaying a highlight on the first cubic GUI which corresponds to the first broadcast channel among the plurality of cubic GUIs, the controller 130 may control the display 110 to display a broadcast content of the first broadcast channel which corresponds to the first cubic GUI on the main screen. As another example, a user may select a screen which displays a content corresponding to the selected cubic GUI by using a mouse. Specifically, in response to the mouse being clicked and the second cubic GUI being dragged to the first sub-screen while a pointer is being placed on the second cubic GUI which corresponds to the second broadcast channel, the controller 130 may control the display 110 to display the second broadcast channel corresponding to the second cubic GUI on the first sub-screen. As another example, a user may select a screen which displays a content corresponding to the selected cubic GUI by using hand motion. Specifically, in response to a first user motion (e.g., grab motion) being inputted and a second motion (e.g., moving motion) to move the second cubic GUI to an area of the second sub-screen being inputted while the pointer is being placed on the third cubic GUI which corresponds to the first SNS content among the plurality of cubic GUIs, the controller 130 may control the display 110 to display the first SNS content which corresponds to the third cubic GUI on the second sub-screen.

As described above, through various user interactions, a content that a user requests may be more intuitively displayed on a screen that a user requests among the plurality of screens.

According to an exemplary embodiment, in response to a predetermined first user interaction being inputted through the user interface 110 while the plurality of screens are displayed on the first area of the display screen and the plurality of objects are displayed on the second area of the display screen, the controller 130 may control the display 110 to remove the plurality of objects displayed on the second area of the display screen, and expand and display the plurality of screens displayed on the first area of the display screen. Specifically, in response to an interaction to select a predetermined button (e.g., screen converting button) being inputted through the remote controller in the user interface 110 while the plurality of screens are displayed on the first area of the display screen and the plurality of cubic GUIs are displayed on the second area of the display screen, the controller 130 may control the display 110 to remove the plurality of cubic GUIs displayed on the lower area of the displays screen by fading them out, expand and display the main screen and the plurality of sub-screens displayed on the upper area of the display screen.

Herein, in response to a predetermined second user interaction being inputted through the user interface 120 while the plurality of screens are expanded and displayed on the display screen, the controller 130 may control the display 110 to reduce a size of the main screen among the plurality of screens, and display a plurality of thumbnail screens which correspond to the plurality of contents toward a predetermined direction based on the reduced main screen. Specifically, in response to a rubbing interaction to rub the OJ sensor provided on the remote controller in the user interface 120 is inputted while the main screen and the plurality of sub-screens are displayed, the controller 130 may control the display 110 to reduce a size of the main screen, and display a plurality of thumbnail screens which correspond to other broadcast channels toward the upper and the lower directions based on the reduced main screen. Herein, the controller 130 may control the display 110 to display broadcast channel information which correspond to the thumbnail screens on one side from the plurality of thumbnail screens.

Further, in response to one thumbnail screen being selected from the thumbnail screens which correspond to the plurality of contents through the user interface 120, the controller 130 may control the display 110 to reproduce a content which corresponds to the selected thumbnail screen on the main screen. Specifically, in response to a user command to move toward the upper and the lower directions (e.g., a command to rub the OJ sensor toward the upper or the lower directions) being input while a highlight is displayed on the reduced main screen and the plurality of thumbnail screens are displayed toward the upper and the lower directions based on the main screen, the controller 130 may control moving the plurality of thumbnails according to the upper and lower moving command and display a highlight on one of the plurality of thumbnails. Further, in response to a user confirmation command (e.g., command to push the OJ sensor) being input while a highlight is displayed on one of the plurality of thumbnails, the controller 130 may control the display 110 to expand the thumbnail screen marked with a highlight and display a broadcast channel which corresponds to the selected thumbnail screen on a position of the main screen.

According to an exemplary embodiment, in response to a predetermined third user interaction being inputted through the user interface 120 while the plurality of screens are displayed on the first area of the display screen and the plurality of objects are displayed on the second area of the display screen, the controller 130 may control the display 110 to remove the plurality of screens displayed on the first area of the display screen from the display screen, expand and display the plurality of objects displayed on the second area of the display screen. Specifically, in response to an interaction to select a predetermined button (e.g., previous button) being inputted through the remote controller in the user interface 120 while the plurality of screens are displayed on the first area of the display screen and the plurality of cubic GUIs are displayed on the second area of the display screen, the controller 130 may control the display 110 to remove the plurality of screens displayed on the upper area of the display screen from the display screen, expand and display cubic GUIs included in the first group among the plurality of cubic GUIs categorized into a plurality of groups displayed on the lower area of the display screen.

In response to one button being selected from the first to the third buttons provided on the remote controller respectively corresponding to the main screen, the first and the second sub-screens while one object is selected among the plurality of expanded objects, the controller 130 may control the display 110 to remove the plurality of expanded objects from the display screen, re-display the plurality of screens on the display screen, and reproduce a content which corresponds to the selected object on a screen corresponding to the selected button. Specifically, in response to the second button provided on the remote controller being selected while a highlight is displayed on one cubic GUI among the plurality of expanded cubic GUIs, the controller 130 may control the display 110 to remove the plurality of cubic GUIs that are currently displayed from the display screen, re-display the plurality of screens, and display a content which corresponds to the selected cubic GUI on the first sub-screen which corresponds to the second button among the plurality of screens.

As described, a user may reproduce a content that he/she requests on one screen among the plurality of screens in the various methods according to the situation.

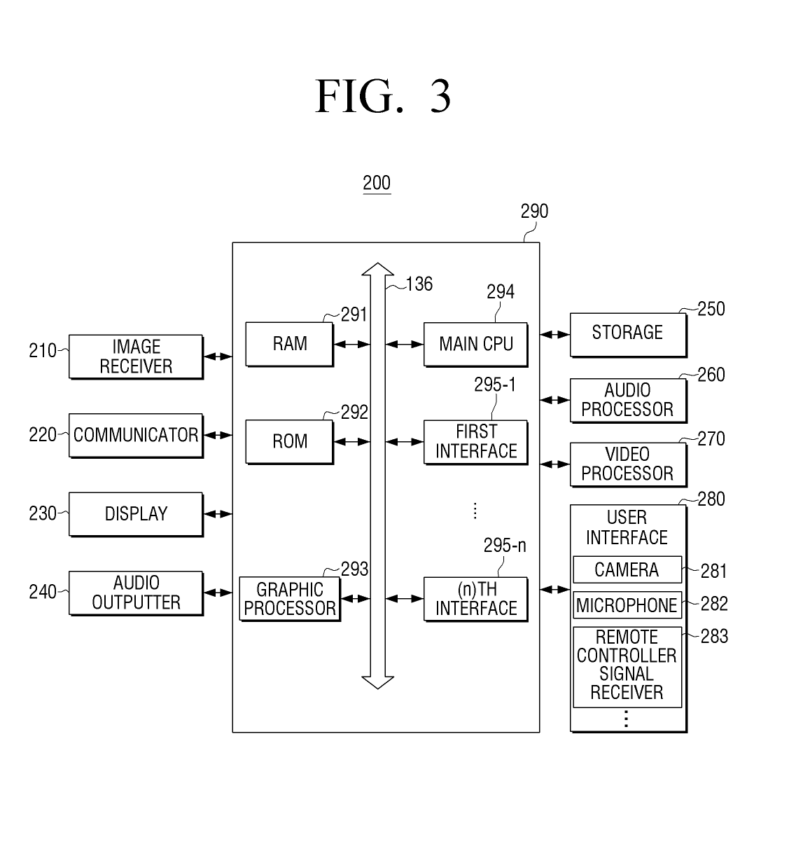

FIG. 3 is a detailed block diagram of the display apparatus according to another exemplary embodiment. Referring to FIG. 3, the display apparatus 200 according to an exemplary embodiment includes an image receiver 210, a communicator 220, a display 230, an audio outputter 240, a storage 250, an audio processor 260, a video processor 270, a user interface 280 and a controller 290.

The image receiver 210 receives image data through various sources. For example, the image receiver 210 may receive broadcast data from external broadcast stations, image data from external devices (e.g., DVD and BD players), and image data stored on the storage 250. Specifically, the image receiver 210 may be provided with a plurality of image receiving modules so as to display the plurality of screens on one display screen. For example, the image receiver 210 may be provided with a plurality of tuners so as to simultaneously display the plurality of broadcast channels.

The communicator 220 is device which performs communication with various types of external devices or external servers according to various types of communication methods. The communicator 220 may include a WiFi chip, a Bluetooth® chip, an NFC chip, and a wireless communication chip. Herein, the WiFi chip, the Bluetooth® chip and the NFC chip respectively perform communication according to WiFi method, Bluetooth® method, and NFC method. NFC chip indicates a chip which operates according to the NFC (near field communication) method which uses 13.56 MHz bandwidth among the various RF-ID frequency bandwidths such as 135 kHz, 13.56 MHz, 433 MHz, 860˜960 MHz, and 2.45 GHz. In response to a WiFi chip or a Bluetooth® chip being used, various connecting information such as SSID and session keys are first trans-received, and various information may be next trans-received after connecting communication with the connecting information. The wireless communication chip indicates a chip which performs communication according to various communication methods such as IEEE™, Zigbee®, 3G (3^{rd} generation), 3GPP (3^{rd} generation partnership project), and LTE (long term evolution).

The display 230 displays at least one video frame from video frames which the image data received by the image receiver 210 are processed in the video processor 270 and various screens generated in a graphic processor 293. Specifically, the display 230 may display the plurality of screens on the first area of the display screen according to a predetermined user command, and the plurality of objects categorized into a plurality of groups on the second area of the display screen. Specifically, the display 230 may display the main screen on a center of the upper area on the display screen and the first and the second sub-screens on a left side and a right side of the main screen. Further, the display 230 may display the plurality of objects in a trapezoidal form displayed on a predetermined area according to the categorized groups on the lower area of the display screen. Herein, the plurality of objects may be hexagonal, and as described, hexagonal objects may be named as cubic GUIs. However, this is merely one of various exemplary embodiments; objects may have a dimension shape such as triangular prism, hexagonal prism, hexahedron and sphere. Further, objects may have a plane shape such as quadrangle, a circle and a triangle.

Specifically, the display 230 may display a plurality of cubic GUIs included in the first group to provide broadcast contents on a first dimensional area, a plurality of cubic GUIs included in the second group to provide video on demand (VOD) contents on a second dimensional area, and a plurality of cubic GUIs included in the third group to provide SNS contents on a third dimensional area. However, the categorized groups described above are merely one of various exemplary embodiments. Categorized groups according to other standards may be applied. For example, categorized groups may be provided by various standards such as group including cubic GUI to provide image contents provided from external devices (e.g., DVD) connected with the display apparatus 200, group including cubic GUI to provide picture contents, and group including cubic GUI to provide music contents. The plurality of screens and the plurality of objects provided by the display apparatus 200 will be explained in detail by referring to drawings in a later part of the specification.

The audio outputter 240 is device which outputs various alarm sounds and voice messages as well as various audio data processed in the audio processor 260. Specifically, the audio outputter 240 may be implemented to be speaker; this is merely one of embodiments. It may be implemented to be another audio outputter such as an audio outputting component.

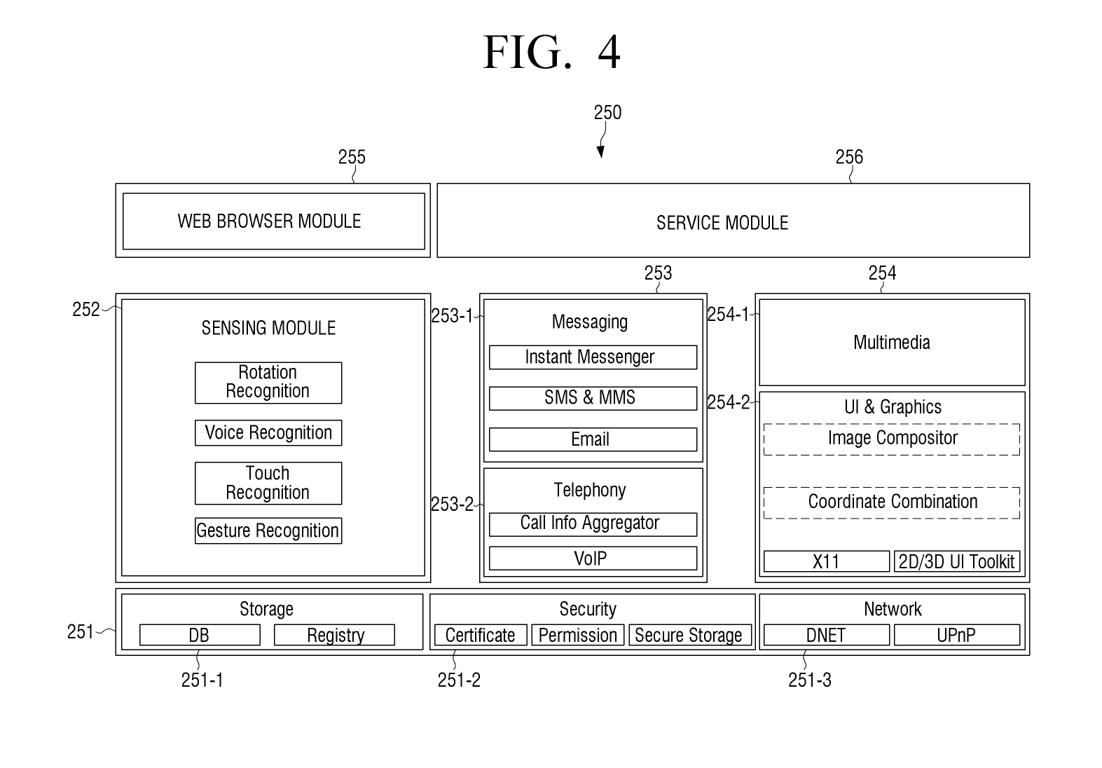

The storage 250 stores various modules to drive the display apparatus 200. Constitution of the storage 250 will be explained by referring to FIG. 4.

FIG. 4 is a view provided to explain the architecture of software stored on the storage 250.

Referring to FIG. 4, the storage 250 may store software including base module 251, sensing module 252, communicating module 253, presentation module 254, web browser module 255, and service module 256.

The base module 251 indicates a basic module which processes signals delivered from each of hardware included in the display apparatus 200 and delivers the processed signals to an upper layer module. The base module 251 includes storage module 251-1, security module 251-2 and network module 251-3. The storage module 251-1 is program module which manages a database (DB) or registry. A main CPU 294 may read various data by using the storage module 251-1 and accessing a database within the storage 250. The security module 251-2 is a program module which supports hardware certification, request permission, and secure storage. The network module 251-3 is a module which supports a connecting network and includes a DNET module and a UPnP module.

The sensing module 252 is module which collects information from various sensors, analyzes and manages the collected information. The sensing module 252 may include head direction recognizing module, face recognizing module, voice recognizing module, motion recognizing module, and NFC recognizing module.

The communicating module 253 is module which externally performs communication. The communicating module 253 may include messaging module 253-1 such as messenger program, SMS (short message service) & MMS (multimedia message service) program and e-mail program and a call module 253-2 including a call info aggregator program module and a VoIP module.

The presentation module 254 is module which generates the display screen. The presentation module 254 includes multimedia module 254-1 to reproduce and output multimedia contents and a UI rendering module 254-2 to perform UI and graphic processing. The multimedia module 254-1 may include a player module, a camcorder module, and a sound processing module. Thereby, the multimedia module 254-1 performs operation of generating and reproducing screens and sounds by reproducing various multimedia contents. UI rendering module 254-2 may include an image compositor module to combine images, a coordinate combining module to combine and generate coordinates on the screens where images are displayed, an X11 module to receive various events from hardware, and a 2D/3D UI toolkit to provide tools which generate UI in 2D or 3D form.

The web browser module 255 indicates a module which performs web browsing and accesses web servers. The web browser module 255 may include various modules such as a web view module to generate web pages, a download agent module to perform downloading, a bookmark module and a Webkit module.

The service module 256 is module which includes various applications to provide various services. Specifically, the service module 256 may include various program modules such as an SNS program, a content reproducing program, a game program, an electronic book program, a calendar program, an alarm managing program, and extra widgets.

Although FIG. 4 illustrates the various program modules, some of the various described program modules may be also deleted, modified, or added according to types and features of the display apparatus 200. For example, an implementation may be made to further include a position based module to support position based service by interlocking with hardware such as a GPS chip.

Back to explaining FIG. 3, the audio processor 260 is device which performs processing relating to audio data. The audio processor 260 may perform various processing such as decoding, amplifying and noise filtering of audio data. The audio processor 260 may be provided with a plurality of audio processing modules so as to process audio which corresponds to the plurality of contents.

The video processor 270 is device which performs processing regarding the received image data from the image receiver 120. The video processor 270 may perform various image processing such as decoding, scaling, noise filtering, frame rate converting, and resolution converting of image data. The video processor 270 may be provided with a plurality of video processing modules so as to process video which corresponds to the plurality of contents.

The user interface 280 is device which senses a user interaction to control overall operation of the display apparatus 200. Specifically, the user interface 280 may sense a user interaction to control the plurality of screens. The user interface 280 may sense various user interactions such as user interaction to move the plurality of screens, user interaction to modify the main screen, and user interaction to select a content to be reproduced on one screen among the plurality of screens. Further, the user interface 280 may sense a user interaction to select a content to be displayed on the plurality of screens. Specifically, the user interface 280 may sense a user interaction to select a content that a user is trying to view and a user interaction to select a screen that the selected content is displayed. Further, the user interface 280 may sense a user interaction to convert the display screen. Specifically, the user interface 280 may sense a user interaction to remove the plurality of screens displayed on the first area from the display screen and a user interaction to remove the plurality of objects displayed on the second area from the display screen.

Further, the user interface 280 may include various interaction sensing devices such as a camera 281, a microphone 282 and a remote controller signal receiver 283, as referred to in FIG. 3.

The camera 281 is a device which photographs still images or video images through the control of a user. Specifically, the camera 281 may photograph various user motions in order to control the display apparatus 200.

The microphone 282 is a device which receives user voices or other extra sounds, and converts them into audio data. The controller 290 may use the user voices inputted through the microphone 282 while calling, or convert into audio data and store them on the storage 250.

In response to the camera 281 and the microphone 282 being provided, the controller 290 may perform a controlling operation according to user voices inputted through the microphone 282 or a user motion recognized by the camera 281. Thus, the display apparatus 200 may operate in a motion controlling mode or in a voice controlling mode. In response to operating in a motion controlling mode, the controller 290 photographs a user by activating the camera 281, tracks changes in the user motion, and performs a corresponding control operation. In response to operating in a voice controlling mode, the controller 290 may operate in a voice recognizing mode which analyzes user voices inputted through the microphone and performs a control operation according to the analyzed user voice.

Further, the remote controller signal receiver 283, which is the external remote controller 50, may receive remote controller signals including a control command from the remote controller.

The controller 290 controls overall operation of the display apparatus 200 by using various stored programs on the storage 250.

The controller 290 includes RAM 291, ROM 292, a graphic processor 293, the main CPU 294, a first to a n interfaces 295-1˜295-n, and a bus 136, as referred to in FIG. 2. Herein, RAM 291, ROM 292, the graphic processor 293, the main CPU 294, and the first to n interfaces 295-1˜295-n may be connected with each other through the bus 136.

ROM 292 stores a set of commands for system booting. In response to a turn-on command being inputted and an electrical source is provided, the main CPU 294 copies O/S stored on the storage 250 to RAM 291 according to the stored commands on ROM 292, and boots the system by implementing the O/S. In response to the completion of booting, the main CPU 294 copies various application programs stored on the storage 250 to RAM 291, and performs various operation by implementing the copied application programs on RAM 291.

The graphic processor 293 generates screens including various objects such as icons, images and texts by using a calculator (not illustrated) and a renderer (not illustrated). The calculator calculates feature values such as coordinate values, shapes, sizes and colors which the objects are respectively displayed according to layouts of the screen by using the received controlling command. The renderer generates screens of various layouts including the objects based on the feature values calculated in the calculator. The screens generated in the renderer are displayed within a display area of the display 230.

The main CPU 294 performs booting by using the stored O/S in the storage 250 by accessing the storage 250. Further, the main CPU 294 performs various operations by using various programs, contents and data stored in the storage 250.

The first to n interfaces 295-1˜295-n are connected with the above various units. One of the interfaces may be network interface connected with an external device through network.

Specifically, the controller 290 may control the display 230 to display the plurality of screens on the first area of the display screen and the plurality of objects categorized into a plurality of groups on the second area of the display screen according to an inputted user interaction to the user interface 280.

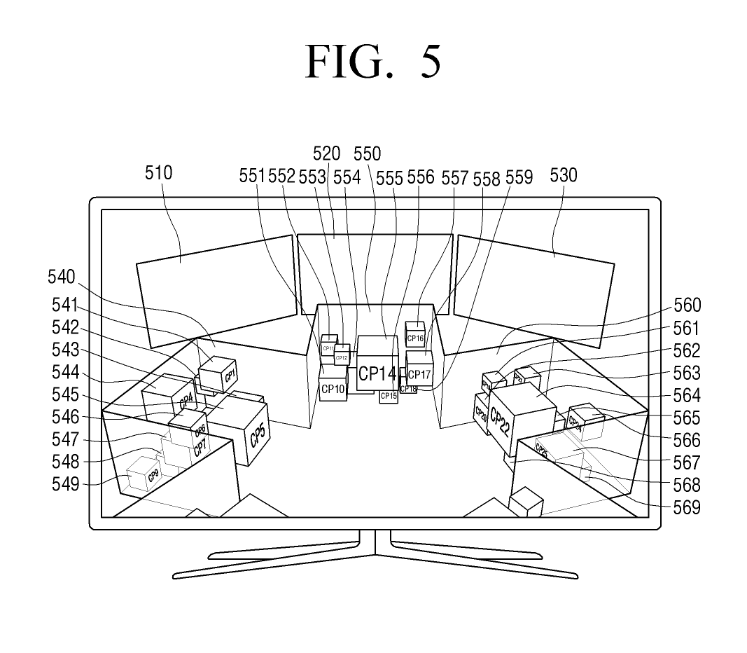

Specifically, the controller 290 may control the display 230 to display the main screen 520 and the plurality of sub-screens 510, 530 on the upper area of the display screen, as referred to in FIG. 5. The controller 290 may control the display 230 to display the main screen 520 on a center of the upper display screen, and the first sub-screen 510 and the second sub-screen 530 that are cubic forms respectively slit toward a left side and a right side of the main screen 520. Herein, the main screen 520 and the plurality of sub-screens 510 and 530 may provide effects whereby a user can view the plurality of screens on a three dimensional area because they are dimensionally arranged.

Although the contents are not reproduced on the main screen 520 and the plurality of sub-screens 510 and 530 in FIG. 5, this is merely one of various exemplary embodiments; previously reproduced contents may be played on the screens.

Further, the controller 290 may control the display 230 to display the objects categorized into a plurality of groups on a plurality of dimensional areas in a room form on the lower area of the display screen. Specifically, referring to FIG. 5, the controller 290 may control the display 230 to display a first room 550 including the plurality of objects 551 to 559 categorized into the first group on a center of the lower display screen, a second room 540 including the plurality of objects 541 to 549 categorized into the second group on a left area of the first room, and a third room 560 including the plurality of objects 561 to 569 categorized into the third group on a right area of the first room. Herein, each of the plurality of objects included in the plurality of rooms 540, 550, 560 may be cubic GUI in a hexahedron form, floated and displayed within the plurality of rooms having three dimensional areas.

According to an exemplary embodiment, the first room 550 includes the first cubic GUI to the ninth cubic GUI 551 to 559 which correspond to broadcast channels, the second room 540 includes the tenth cubic GUI to the eighteenth cubic GUI 541 to 549 which correspond to SNS contents, and the third room 560 includes the nineteenth cubic GUI to twenty seventh cubic GUI 561 to 569 which correspond to VOD contents. However, as described above, the categorized cubic GUIs are merely one of various exemplary embodiments; cubic GUIs may be categorized according to other standards. For example, cubic GUIs may be categorized according to various standards such as cubic GUIs to provide image contents provided from an external device (e.g., DVD) connected with the display apparatus 200, cubic GUIs to provide picture contents, cubic GUIs to provide music contents, and cubic GUIs to provide application contents.

In addition, a room may be implemented as a personalized room including a cubic GUI which corresponds to a content designated by a user. For example, a personalized room of a user A may include a cubic GUI which corresponds to a content designated by the user A, and a personalized room of a user B may include a cubic GUI which corresponds to a content designated by the user B. At this point, in order to enter into a certain personalized room, an authentication process of a user may be required (for example, a process of inputting ID and a password, a process of recognizing a face, and the like.)

Herein, the controller 290 may control the display 230 to modify and display at least one of a size and arrangement situation regarding the cubic GUIs included in the plurality of rooms 540, 550, 560, based on at least one of user contexts and content features regarding contents which correspond to the cubic GUIs.

User contexts regarding contents may indicate meaning which includes all using records, using situations, and using environments related to the contents. Specifically, the user contexts may include past using experiences, current using experiences, and future expected using experiences of a user. For example, in response to the content being broadcast channel content, currently selecting as well as past selecting regarding a corresponding broadcast channel may correspond to the user contexts. A user meaning may include other users putting predetermined influences on the contents or service providers, as well as a user of the display apparatus 200. For example, in response to the content indicating certain content uploaded on SNS, another user inputting a comment relating to corresponding content may belong to a user. Further, the context regarding contents may include various surrounded environments such as time flows, positions of the display apparatus 200 (e.g., local area) and surrounded lights.

Further, the content features may mean including all of the features that can distinguish the content according to exemplary embodiments of implementing contents. For example, in response to the content being image content, the content features may be various features that can be distinguished from the other contents such as content descriptions, content reproducing time, updating time, broadcast time, playing time, and actors that can occur while reproducing, distributing and consuming the content. Further, in response to the content being SNS content, the content features may be available service types (e.g., picture updating service) and the number of members. Further, in response to the content being broadcast content, the content features may be types and descriptions of the content that can be provided and channel watch rate.

In this case, standards to determine a size and arrangement situation of the cubic GUI may be preset or confirmed in real time. For example, regarding contents such as a broadcast, picture, music, movie, and TV show, a size and arrangement situation may be determined based on user motion patterns. Regarding SNS and education contents, a size and arrangement situation may be preset to be determined based on the content features. However, according to the situation, standards may be set according to a user selection or may be determined in real time in the display apparatus 200.

The size of the cubic GUI may be at least one plane size of six planes. Thus, in response to the size of the cubic GUI being different, a size of at least one plane, i.e., one of a horizontal length and a vertical length, may be different. For example, the size of the cubic GUI may be different in response to a size of the plane to be in front from the viewpoint of a user being different. Further, the size of the cubic GUI may be also different in response to a size of the side plane to be slit from the viewpoint of a user being different.

Further, an arrangement situation of the cubic GUI may include at least one of a position of the cubic GUI on X-Y axes of the screen and a depth of the cubic GUI on Z axis of the screen. In response to an arrangement situation of the cubic GUI being different, a position coordinate of the cubic GUI on X-Y axes of the screen may be different or a position coordinate of the cubic GUI on Z axis of the screen may be different. The depth may indicate a feeling of depth which corresponds to a position toward the front and the back directions, which are view directions of a user.

For example, even in response to positions of the two cubic GUIs being uniform on X-Y axes on the screen, in response to depth positions on Z axis being different, arrangement situations may be different with each other. The depth on the Z axis may be modified according to a +Z direction or −Z direction. This specification describes that the depth decreases in response to a modification according to +Z direction and the depth increases when it is modified according to −Z direction. Thus, the explanation that the depth decreases or the depth is small means that displaying comes nearer to a user. The explanation that the depth increases or the depth is large refers to the display going further away from a user. Regarding 2D images, the depth may be expressed by dimensional processing of the cubic GUI. However, regarding 3D images, the depth may be expressed through disparity between left-eye images and right-eye images.

The controller 290 may control the display 230 to determine an order of priority regarding contents based on at least one of the user contexts and the content features regarding contents, and may display a size and arrangement situation of the cubic GUI which differently indicates the contents according to the determined order of priority.

For example, in response to the plurality of cubic GUIs being respectively displayed on the screens indicating broadcast channels, the controller 290 may control the display 230 to establish an order of priority according to favorite degree which is user context regarding each broadcast channel, display a cubic GUI which indicates a broadcast channel having the highest priority order according to the established priority order on a center of the screen in the largest size, and display a cubic GUI which indicates a broadcast channel having the lowest priority order on the lower right area of the screen in the smallest size. Further, in response to the plurality of cubic GUIs to be displayed on the screens respectively indicating movie contents, the controller 290 may control the display 230 to reduce a depth of a cubic GUI to indicate a movie content that is the newest to be updated according to the updating time, which is one of features regarding movie contents to be smallest and display the cubic GUI near to a user, and expand a depth of a cubic GUI indicating a movie content that is the oldest updated content to be largest and to display the cubic GUI far from a user.

The controller 290 may modify and display content information according to order of priority of the content while previously establishing a display position, a depth and a size related to a corresponding position regarding the cubic GUI; the controller 290 may freely modify a position, a size and a depth of the cubic GUI which indicates the content according to the order of priority of the content. For example, in response to modifying the order of priority of the cubic GUI displayed on a center of the screen to have the largest size and the largest depth, the controller 290 may display information of corresponding content on another cubic GUI while keeping a position, a depth and a size of the corresponding cubic GUI; the controller may also modify at least one of the size, the position and the depth of the corresponding cubic GUI.

Further, the controller 290 may control displaying the size and situation arrangement of the cubic GUI differently, according to the type of the content that the cubic GUI currently indicates.

For example, the controller 290 may modify at least one of the size, the position and the depth of the cubic GUI according to the order of priority of content providers and the order of priority of contents so that the plurality of cubic GUIs can indicate content information provided from corresponding content providers according to a predetermined event, while the plurality of cubic GUIs indicate content provider information. The size and the position of the cubic GUI may be displayed to correspond with the order of priority of content providers and the depth of the cubic GUI may be displayed according to the order of priority of the contents.

Further, the controller 290 may control the display 230 to display information regarding a content which corresponds to the cubic GUI on at least one plane among the plurality of planes constituting the cubic GUI. For example, in response to the cubic GUI corresponding to a broadcast content, the controller 290 may control the display 230 to display a broadcast channel name, a broadcast channel number, and program information, on one plane of the cubic GUI.

Further, the controller 290 may select one cubic GUI from the plurality of cubic GUIs by controlling the display 230 to display a highlight on the plurality of cubic GUIs. In this process, the controller 290 may move a highlight only on the second room 550 placed on a center area among the plurality of rooms 540, 550, 560. Thus, the controller 290 may display and move a highlight on one cubic GUI among the plurality of cubic GUIs 551 to 559 included in the second room 550. In order to select a cubic GUI included in the other rooms, the controller 290 may move another room on a center area through a user interaction, and select one cubic GUI from the plurality of cubic GUIs included in the room moved to the center area.

In response to a highlight being displayed on one cubic GUI from the plurality of cubic GUIs, the controller 290 may control the display 230 to display the cubic GUI marked with a highlight in a different method from the other cubic GUIs. For example, the controller 290 may control the display 230 to display a broadcast channel number, a broadcast program name, and a broadcast program thumbnail screen on the cubic GUI marked with a highlight, and display only a broadcast channel name on the other cubic GUIs unmarked with a highlight.

The above exemplary embodiment describes that one cubic GUI is selected from the plurality of cubic GUIs by moving a highlight; however, this is merely one of various exemplary embodiments, and one cubic GUI may be selected from the plurality of cubic GUIs by using the pointer.

In response to a predetermined user interaction being inputted while one object is selected from the plurality of objects, the controller 290 may control the display 230 in order to display a content which corresponds to the selected object on one screen among the plurality of screens, according to the inputted predetermined user interaction. Herein, the predetermined user interaction may be user interaction to select one of the first to the third buttons which respectively correspond to the main screen 520, the first sub-screen 510 and the second sub-screen 530. Specifically, the first to the third buttons provided on the remote controller may be the same shape as that of the main screen 520, the first sub-screen 510 and the second sub-screen 530.

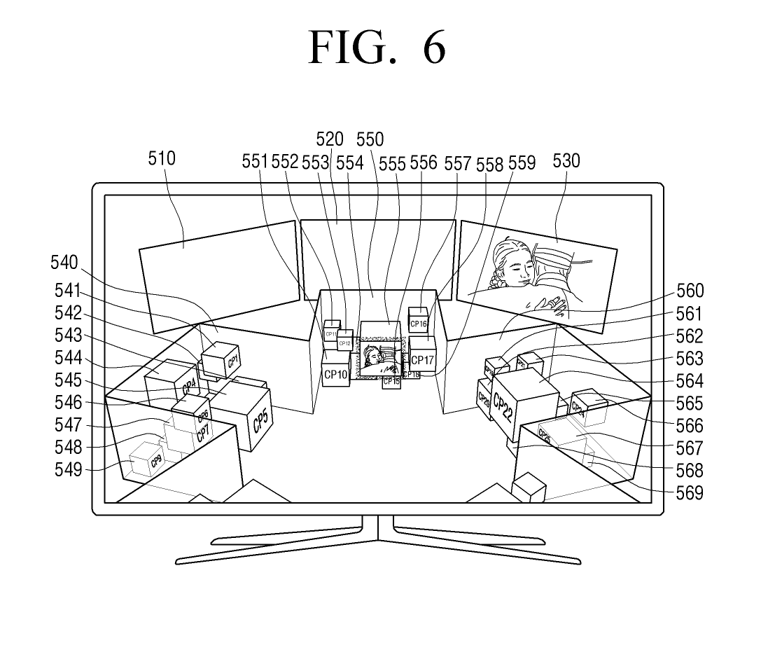

Specifically, referring to FIG. 5, in response to the third button being selected from the first to the third buttons provided on the remote controller while a highlight is displayed on the fourteenth cubic GUI 555 placed on a center among the plurality of cubic GUIs included in the first room 550, the controller 290 may control the display 230 to display a broadcast content which corresponds to the fourteenth cubic GUI 555 on the second sub-screen 530 corresponding to the third button, as referred to in FIG. 6.

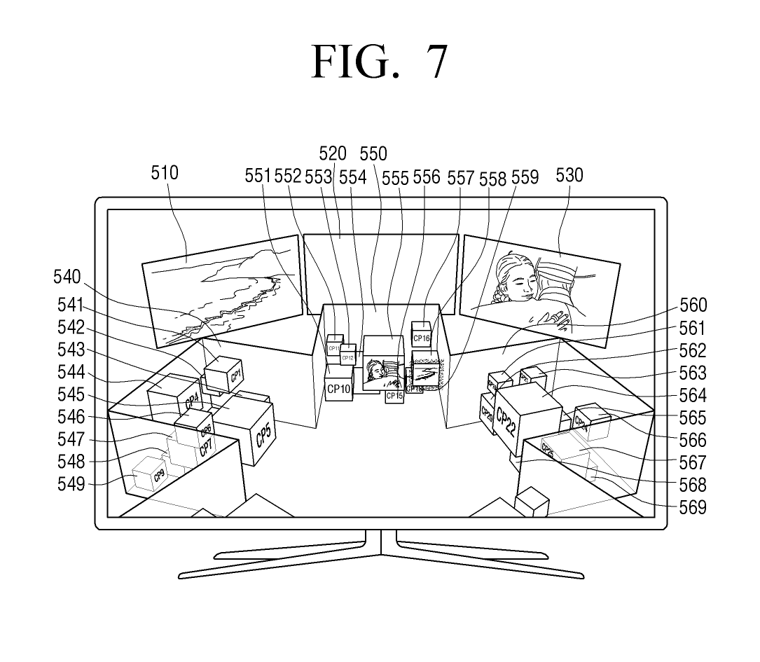

Further, in response to the first button being selected among the first to the third buttons provided on the remote controller after moving a highlight to the sixteenth cubic GUI 557 according to a user command inputted through the user interface 280, the controller 290 may control the display 230 to display a broadcast content which corresponds to the sixteenth cubic GUI 557 on the first sub-screen 510 corresponding to the first button, as referred to in FIG. 7.

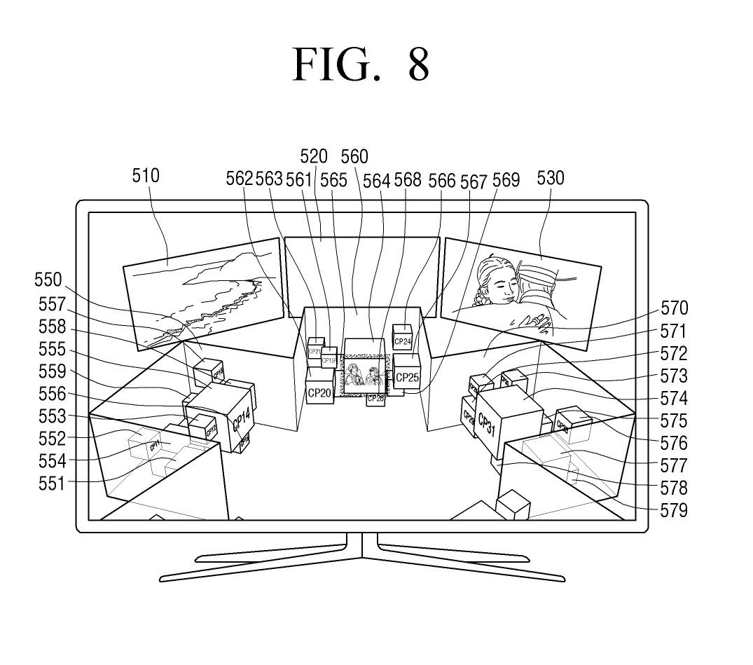

Further, in response to a user command to rotate a room being inputted through the user interface 280, the controller 290 may control the display 230 to rotate and display the plurality of rooms. Specifically, in response to a user command to rotate a room counter-clockwise being input through the user interface 280, the controller 290 may control the display 230 to rotate the plurality of rooms 540, 550, 560 counter-clockwise, remove the first room 540 from the display screen, move the third room 560 to a center of the display screen, display the second room 550 on a left side of the third room 560, generate a fourth room 570 and display the fourth room 570 on a right side of the third room 560, as referred to in FIG. 8.

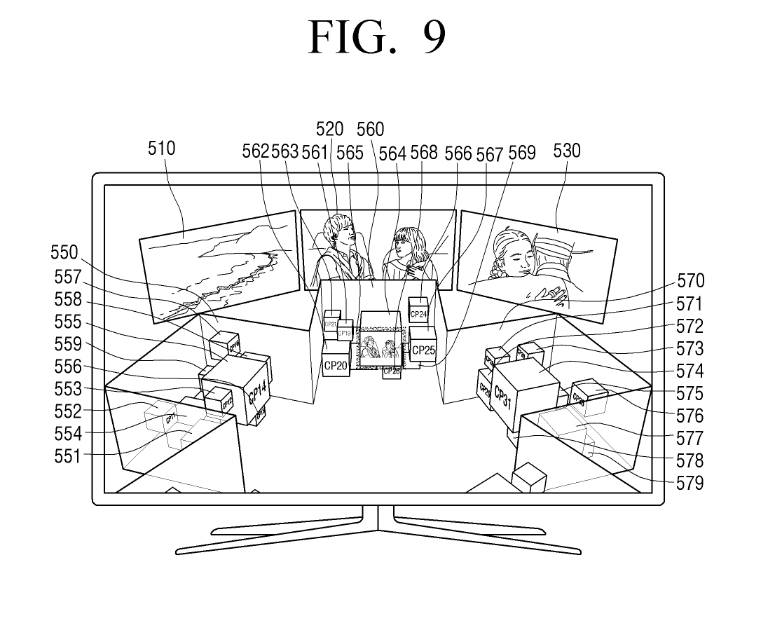

In response to the second button being selected among the first to the third buttons provided on the remote controller after moving a highlight to the twenty second cubic GUI 564 according to a user command inputted through the user interface 280, the controller 290 may control the display 230 to display VOD content which corresponds to the twenty second cubic GUI 564 on the main screen 520 corresponding to the second button, as referred to in FIG. 9.

As described above, contents may be selected and displayed on the plurality of screens according to a user interaction using the remote controller. Thus, a user may simultaneously view the plurality of contents that he/she requests through the plurality of screens. Further, because a user may continuously confirm contents that he/she will request while selecting a content to be displayed on the plurality of screens, he/she can more conveniently select contents.

The above exemplary embodiment selects a screen which a content is displayed by using the remote controller. However, this is merely one of various exemplary embodiments. Accordingly, a screen which a content is displayed may be selected by using other methods.

For example, a user may select a screen on which a content is displayed by using a voice command. Specifically, in response to a voice command of “main” being inputted through the microphone 282 of the user interface 280 while a highlight is displayed on one cubic GUI among the plurality of cubic GUIs, the controller 290 may control the display 280 to display a content which corresponds to the cubic GUI marked with a highlight on the main screen corresponding to the user voice. A user voice to select the plurality of screens may be implemented according to various exemplary embodiments. For example, a user voice to select the first sub-screen may be variously implemented as “first sub,” “left” or “left direction.”

As another example, a user may select a screen on which a content is displayed by using the pointer controlled with a pointing device or user motion. In response to a user selecting command (e.g., mouse clicking or user grab motion) being input and a drag command to move toward one of the plurality of screens (e.g., a mouse moving while keeping the mouse clicking or a user moving while keeping grab motion) being inputted while one pointer is placed on one of the plurality of cubic GUIs, the controller 290 may control the display 230 to display a content which corresponds to the cubic GUI that the pointer is placed on a screen moved according to the dragging command.

The controller 290 may select a content to be displayed on the plurality of screens according to various methods. According to an exemplary embodiment, in response to a predetermined user interaction being inputted while the plurality of screens are displayed on the display screen, the controller 290 may control the display 230 to reduce the main screen among the plurality of screens and display the plurality of thumbnail screens which correspond to the plurality of contents that can be displayed on the main screen of the display screen. Thereby, a user may select a content to be displayed on the main screen by using the plurality of thumbnail screens displayed on the display screen.

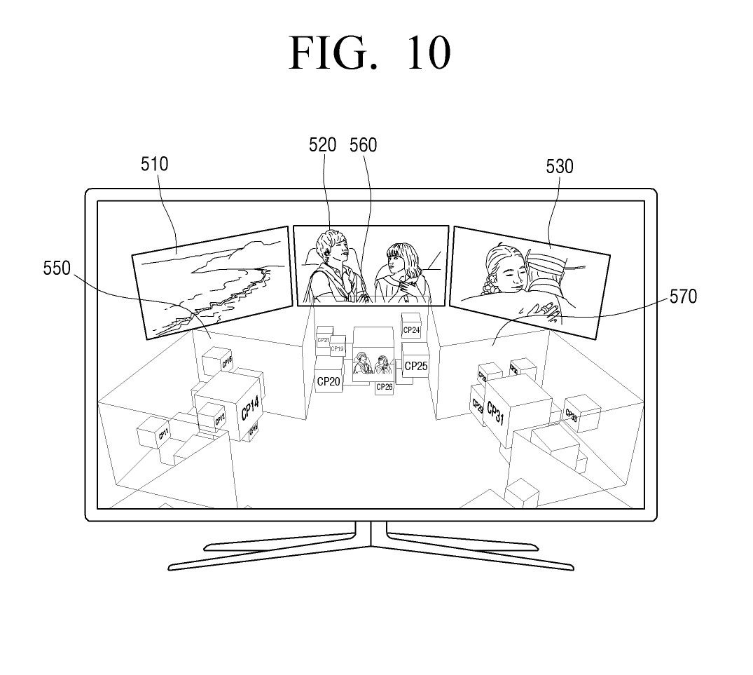

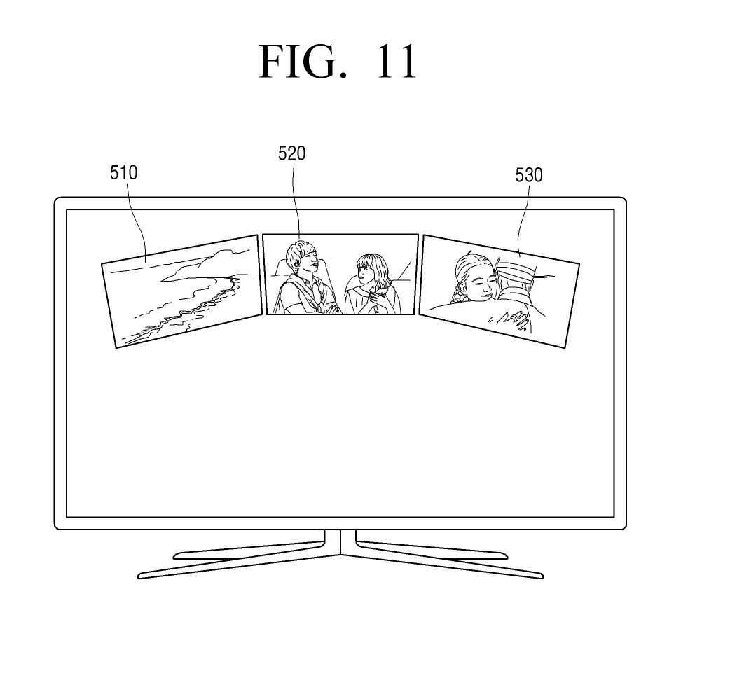

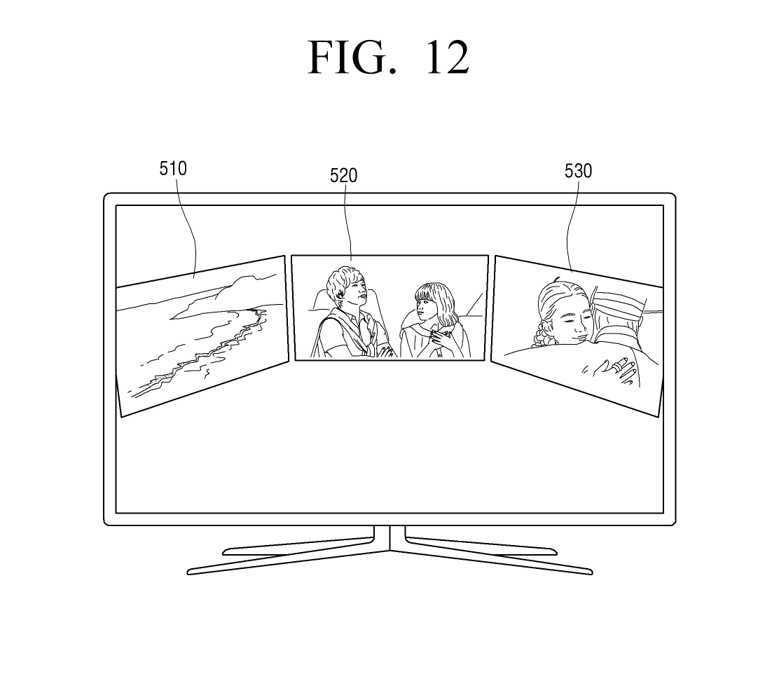

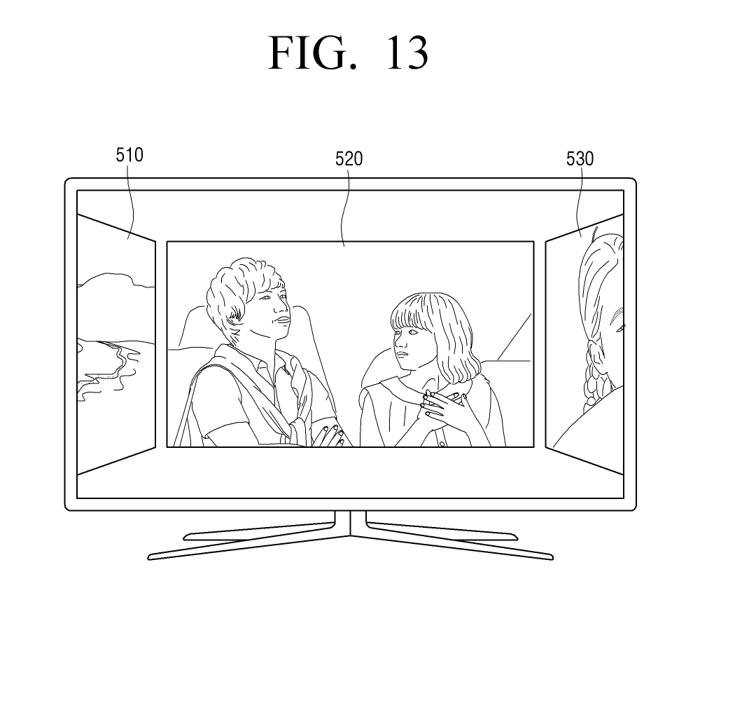

Specifically, in response to a predetermined user interaction being input while the plurality of screens are displayed on the first area of the display screen and the plurality of objects are displayed on the second area of the display screen, the controller 290 may control the display 230 to remove the plurality of objects displayed on the second area of the display screen, and expand and display the plurality of screens. For example, referring to FIG. 9, in response to a predetermined user interaction (e.g., command to select a predetermined button of the remote controller) being detected through the user interface 280 while the main screen 520 and the plurality of sub-screens 510, 530 are displayed on the upper area of the display screen and the plurality of cubic GUIs are displayed on the plurality of rooms 540, 550, 560 on the lower area of the display screen, the controller 290 controls the display 230 to fade out the plurality of cubic GUIs displayed on the second area of the displays screen according to time flows, as referred to in FIG. 10 and remove them from the display screen as referred to in FIG. 11. Further, as illustrated in FIGS. 12 and 13, the controller 290 may control the display 230 to expand and display the main screen 520 and the plurality of sub-screens 510, 530 displayed on the upper area. As described with reference to FIGS. 10 to 13, expanding and displaying the main screen 520 and the plurality of sub-screens 510, 530 is merely one of various exemplary embodiments. Accordingly, the main screen 520 and the plurality of sub-screens 510, 530 may be expanded and displayed according to other methods. For example, the controller 290 may control the display 230 to remove the plurality of cubic GUIs displayed on the lower area by moving them toward a lower direction, simultaneously expand and display the main screen 520 and the plurality of sub-screens 510, 530. Through this process, the controller 290 may display a plurality of images received from an external broadcast station through the plurality of tuners on the plurality of screens among the main screen 520 and the plurality of sub-screens 510, 530 in real time.

Referring to FIG. 13, the method of displaying the plurality of screens which performs the processes of FIGS. 9 to 13 is merely one of various exemplary embodiments. The plurality of screens may be only displayed on the display screen through other methods. For example, in response to the display apparatus 200 turning on for the first time, the controller 290 may control the display 230 to display only the plurality of screens on the display screen.

The controller 290 may control the display 230 to display the plurality of screens on the display screen, as referred to in FIG. 13. Specifically, the controller 290 may control the display 230 to respectively display the plurality of contents received from the image receiver 210 on the plurality of screens. For example, the controller 290 may display a first broadcast content received through the first tuner on the first sub-screen 510, a second broadcast content received through the second tuner on the second sub-screen 530, and a first VOD content received through an external server on the main screen 520.

Further, the controller 290 may control display 230 to respectively display the main screen 520 on a center area of the display screen, and the first sub-screen 510 and the second sub-screen 530 on a left side and a right side of the main screen 520, as referred to FIG. 13. Specifically, the controller 290 may establish the screen having the largest ratio on the display 230 as main screen 520, and output audio of the main screen through the audio outputter 240. Further, the controller 290 may control the display 230 to display the first sub-screen 510 and the second sub-screen 530 which reproduces the contents that a user is trying to search on a left side and a right side of the main screen. Herein, audio related to the first sub-screen 510 and the second sub-screen 530 may not be outputted or may have output levels below a predetermined value.

Further, referring to FIG. 13, the controller 290 may control the display 230 to display the first sub-screen 510 and the second sub-screen 530 in a trapezoid form on a left side and a right side of the main screen 520. The first sub-screen 510 and the second sub-screen 530 displayed in a trapezoid form may be displayed as being placed dimensionally on a three dimensional area based on the main screen 520. Thus, a user may have the effect of controlling the plurality of screens on a three dimensional area.

Further, referring to FIG. 13, the controller 290 may control the display 230 to display parts of the screens without displaying all of the first sub-screen 510 and the second sub-screen 530.

In addition, the controller 290 may control the display 230 to move and modify positions of the main screen 520 and the plurality of sub-screens 510, 530 according to the user interaction detected through the user interface 280.

The user interaction may include a user interaction to have directivity and a user interaction to directly select one screen among the plurality of screens through the user interface 280.

The following will explain an exemplary embodiment which the plurality of screens are moved in response to a user interaction to shake a user head, which is a user interaction to have directivity, being detected.

Referring to FIG. 13, the controller 290 may detect whether a user head is shaking, through the photographer 281, while the main screen 510 and the plurality of sub-screens 520, 530 are displayed on the display 230.

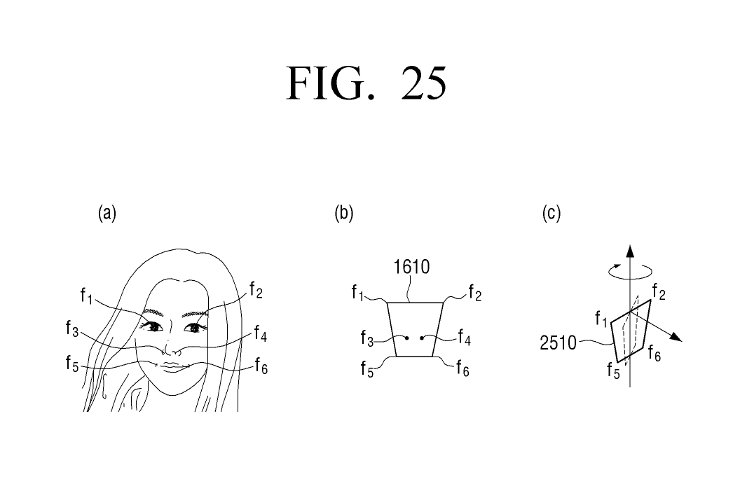

A method of detecting shaking of a user head will be described by referring to FIG. 25. Specifically, while the photographer 281 photographs an area including a user, the controller 290 may detect a user face from the images photographed by the photographer 281. Further, referring to FIG. 25A, the controller 290 detects a plurality of feature points f1 to f6. The controller 290 generates a virtual figure 2410 by using the detected feature points f1 to f6, referring to FIG. 25C. Further, the controller 290 may determine whether the user's head shakes by determining changes in the virtual figure 2410, referring to FIG. 25C. Specifically, the controller 290 may determine a direction and an angle regarding shaking of a user head according to changes in the shape and the size of the virtual figure 2410, as referred to in FIG. 25C.

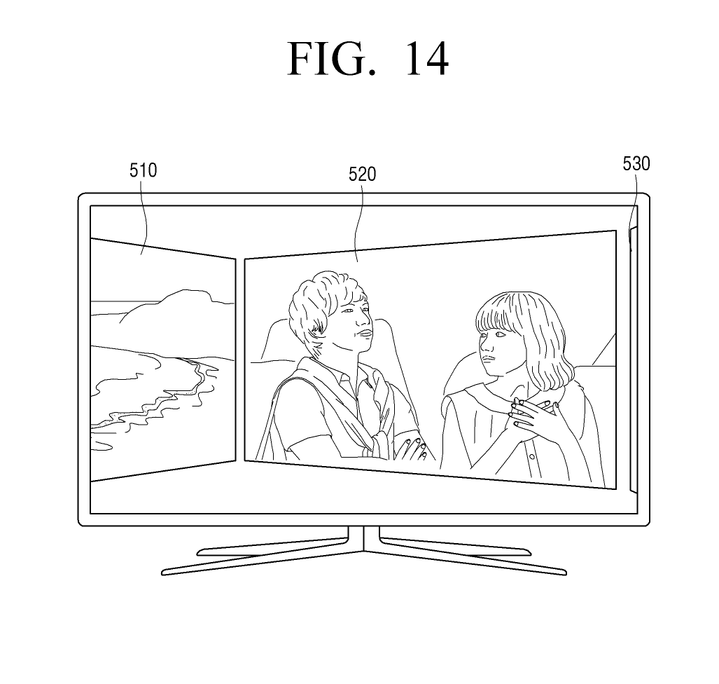

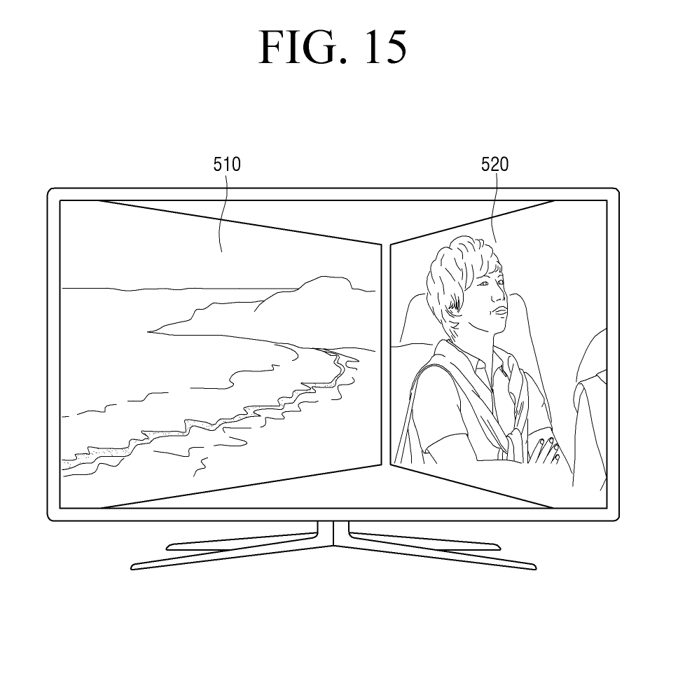

In response to shaking of a user head being sensed, the controller 290 may control the display 230 to move the main screen 520, the first sub-screen 510 and the second sub-screen 530 toward the sensed shaking direction of a user head. Specifically, referring to FIG. 13, in response to a user head being detected as shaking toward a left direction through the camera 281 of the user interface 280 while the plurality of screens 510, 520, 530 are displayed on the display 230, the controller 290 may control the display 230 to move the main screen 520, the first sub-screen 510 and the second sub-screen 530 in a direction toward the right as referred to in FIG. 14. Specifically, the controller 290 may control the display 230 to increase the ratio of an area that the first sub-screen 510 placing on the most left side covers in the display screen, as referred to in FIG. 14. Herein, the controller 290 may move the main screen 510, the first sub-screen 520, and the second sub-screen 530 in real time by determining the moving amount of the main screen 510, the first sub-screen 520 and the second sub-screen 530, according to the sensed shaking angle of a user head. Further, in response to the shaking angle of a user head being more than a predetermined value while the user's head moves toward a left direction, the controller 290 may display the first sub-screen 510, placing on the leftmost side so as to cover the largest area of the display screen, and establish the first sub-screen 510 as new main screen, as referred to in FIG. 15. When the first sub-screen 510 is established to be new main screen, the controller 290 may control the audio outputter 240 to output audio of the first sub-screen 510, which is established to be new main screen.

In response to a user head shaking toward a right direction being sensed through the user interface, the controller 290 may control the display 230 to increase the ratio of an area that the second sub-screen 530 covers the display screen by moving the main screen 520, the first sub-screen 510 and the second sub-screen 530 toward a left direction.

Further, in response to a predetermined user interaction being detected while the plurality of screens are displayed, the controller 290 may control the display 230 to reduce the size of the main screen to be a predetermined size among the plurality of screens, and display the plurality of thumbnail screens which correspond to the plurality of contents on a predetermined direction based on the reduced main screen.

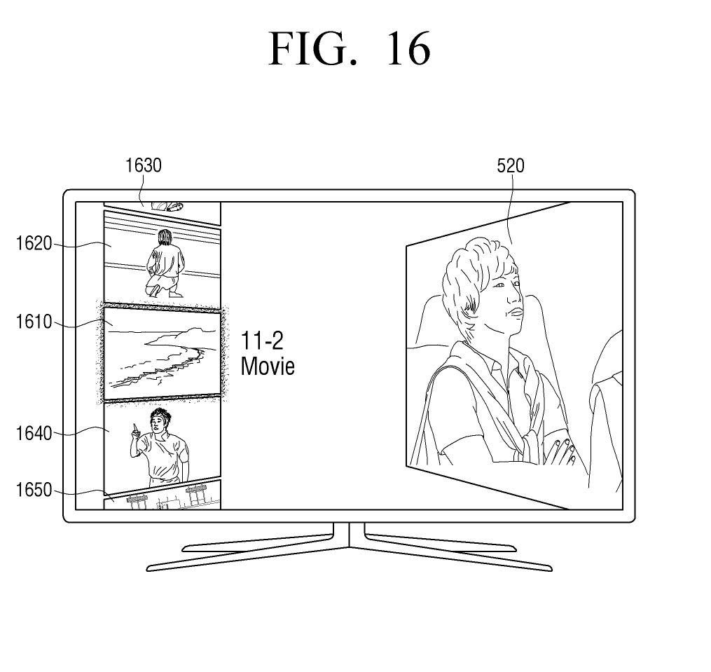

Specifically, referring to FIG. 15, in response to a rubbing interaction toward the upper and the lower directions being input through a OJ sensor provided on the remote controller while the first sub-screen 510 and the previous main screen 520 are displayed, the controller 290 may control the display 230 to reduce the size of the first sub-screen 1610 that is currently established as the main screen to be a predetermined size, and display the plurality of thumbnail screens 1620 to 1650 which correspond to the other broadcast channels on the upper and the lower directions of the reduced first sub-screen 1610, referring to FIG. 16. Herein, the controller 290 may control the display 230 to display a highlight on the reduced first sub-screen 1610, and display information regarding the screen marked with a highlight around the highlighted screen (e.g., channel name, channel number and program name).

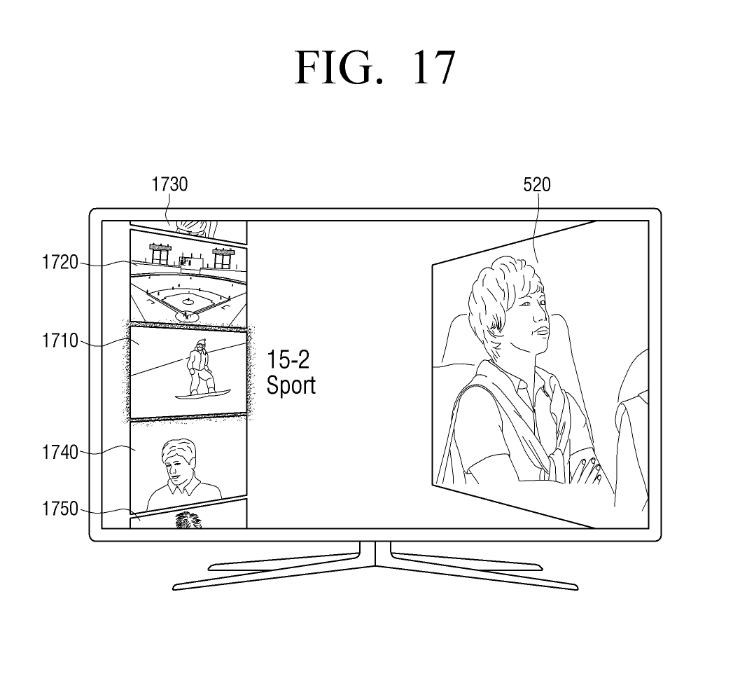

In response to a user interaction toward the upper and the lower directions being sensed through the user interface 280, the controller 290 may modify the thumbnail screen marked with a highlight by moving the thumbnail screens according to the sensed user interaction. Specifically, referring to FIG. 16, in response to a user interaction toward the upper direction being sensed at four times while a highlight is displayed on the thumbnail screen 1610 which corresponds to the broadcast channel “11-2,” the controller 290 may control the display 230 to display a highlight on the thumbnail screen 1710 which corresponds to the broadcast channel “15-1” by moving the plurality of thumbnails, referring to FIG. 17.

Further, in response to a predetermined user interaction being detected while a highlight is displayed on one thumbnail screen from the plurality of thumbnail screens, the controller 290 may control the display 230 to expand and reproduce a content which corresponds to the thumbnail screen marked with a highlight on the main screen.

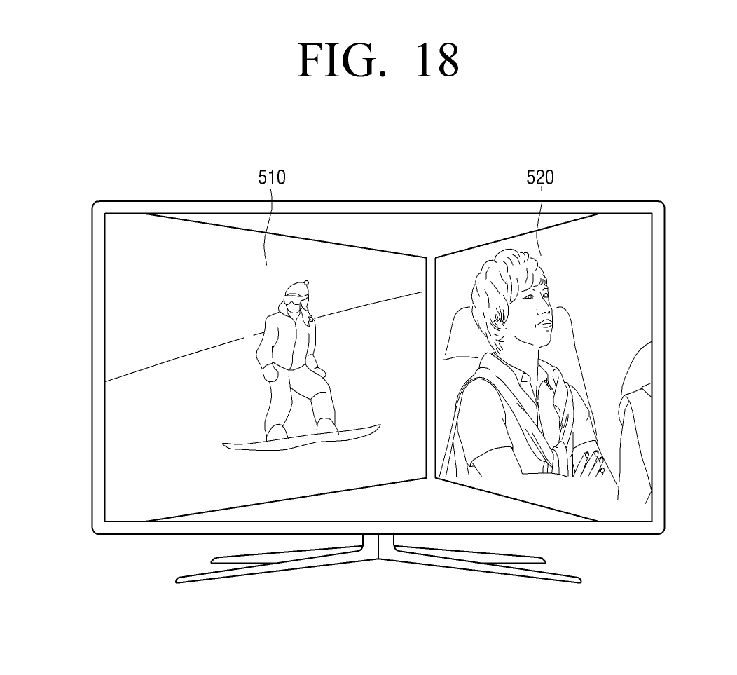

Specifically, referring to FIG. 17, in response to the Enter button of the remote controller being selected while a highlight is displayed on the thumbnail screen 1710 which corresponds to the broadcast channel “15-2,” the controller 290 may control the display 230 to expand a program of the broadcast channel “15-2” which is a content which corresponds to the thumbnail screen marked with a highlight, and reproduce the thumbnail screen marked by the highlight on the first sub-screen 510, which is currently established as main screen, referring to FIG. 18.

As described above, a user may more interestingly and intuitively select a content to be displayed on the main screen by providing the plurality of thumbnail screens which correspond to the plurality of contents that can be displayed on the main screen through a scrawl interaction while the plurality of screens are displayed.

The above exemplary embodiment describes that a broadcast content is selected as content displayed on the main screen through a scrawl interaction; this is merely one of various exemplary embodiments. Other contents may be selected to be displayed on the main screen through a scrawl interaction. For example, contents to be displayed on the main screen through a scrawl interaction may include VOD contents, picture contents, music contents, application contents, web page contents and SNS contents.

According to another exemplary embodiment, in response to a predetermined user interaction being input after displaying only the plurality of objects on the display screen and selecting one icon from the displayed plurality of objects, the controller 290 may control the display 230 to display a content which corresponds to the selected object on one of the plurality of screens, according to the predetermined user interaction.

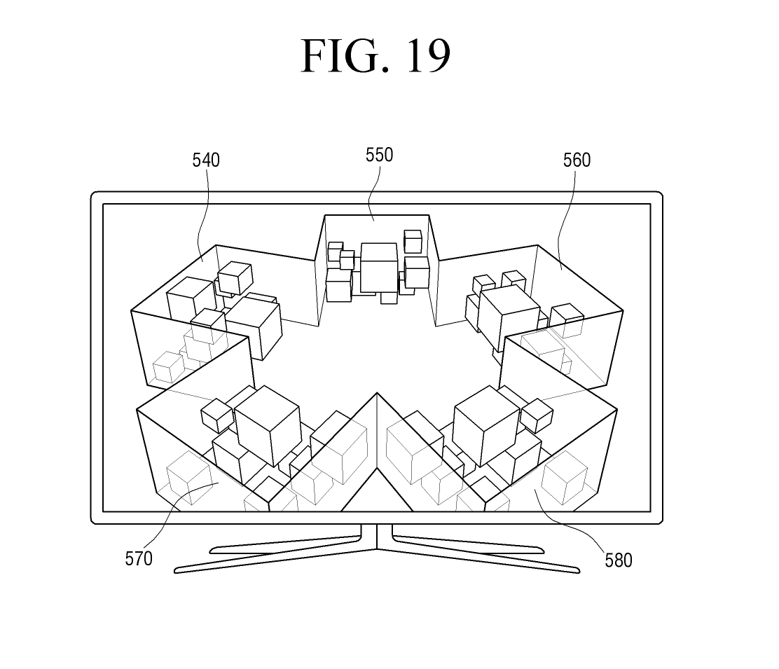

Specifically, in response to a predetermined user interaction (e.g., user command to select a predetermined button provided on the remote controller) being input while the plurality of screens 510, 520, 530 are displayed on the upper area of the display screen and the plurality of cubic GUIs are displayed on the lower area of the display screen, referring to FIG. 9, the controller 290 may control the display 230 to remove the plurality of screens 510, 520, 530 displayed on the upper area of the display screen from the display screen, and expand and display the plurality of rooms including the plurality of objects displayed on the lower area of the display screen, referring to FIG. 19.

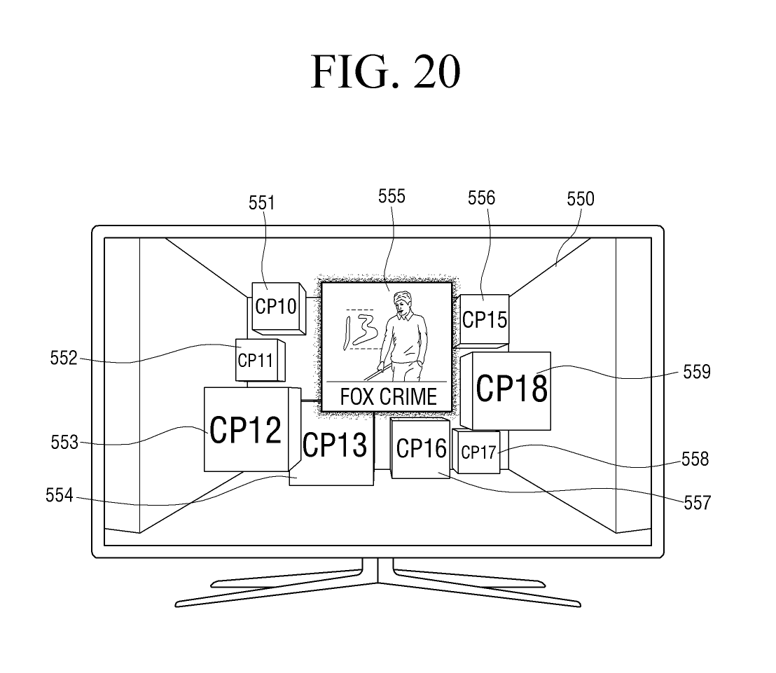

Further, referring to FIG. 19, in response to a predetermined user interaction (e.g., user command to select a menu entering button provided on the remote controller) being input while the plurality of rooms 540 to 580 are displayed referring to FIG. 19, the controller 290 may control the display 230 to expand and display the second room 550 displayed on a center area among the plurality of rooms 540 to 580, as referred to in FIG. 20.

Herein, referring to FIG. 20, the controller 290 may control the display 230 to displays the plurality of cubic GUIs 551 to 559 on the second room 550. The cubic GUIs respectively correspond to broadcast channels, and one plane of the cubic GUI may display information regarding a broadcast channel name, which is content provider (CP). However, the cubic GUI which corresponds to the broadcast channel is merely one of various exemplary embodiments; the cubic GUI may correspond to other contents. For example, the cubic GUI may correspond to various contents such as VOD contents, SNS contents, application contents, music contents and picture contents. The cubic GUI marked with a highlight may be differently displayed from the cubic GUIs unmarked with a highlight. For example, referring to FIG. 20, the cubic GUI 555 marked with a highlight may display thumbnail information and a channel name while the cubic GUIs unmarked with a highlight 551-554, 556-559 display a channel name only.

As described above, the controller 290 may control the display 230 to determine and display at least one of a size and arrangement situation of the cubic GUI based on at least one of the user context and the content features regarding the content which corresponds to the cubic GUI.

Herein, the user context regarding the content may indicate using records, using situations and using environments which are related to the content, and the content features may be various features owned by the content and distinguished from the other contents such as content descriptions, content reproducing time, updating time, broadcast time, playing time and actors regarding the content.

Specifically, the controller 290 may display the cubic GUI which corresponds to the content that a user frequently views to be larger than the other cubic GUIs, place it on a center area, and decrease the depth. Further, the controller 290 may display the cubic GUI which corresponds to the newest updated content to be larger than the other cubic GUIs, place it on a center area, and decrease the depth. For example, the controller 290 may display the cubic GUI 555 which corresponds to the “FOX CRIME” channel, which is viewed frequently by a user among the broadcast channels, to be largest on a center area with a smaller depth.

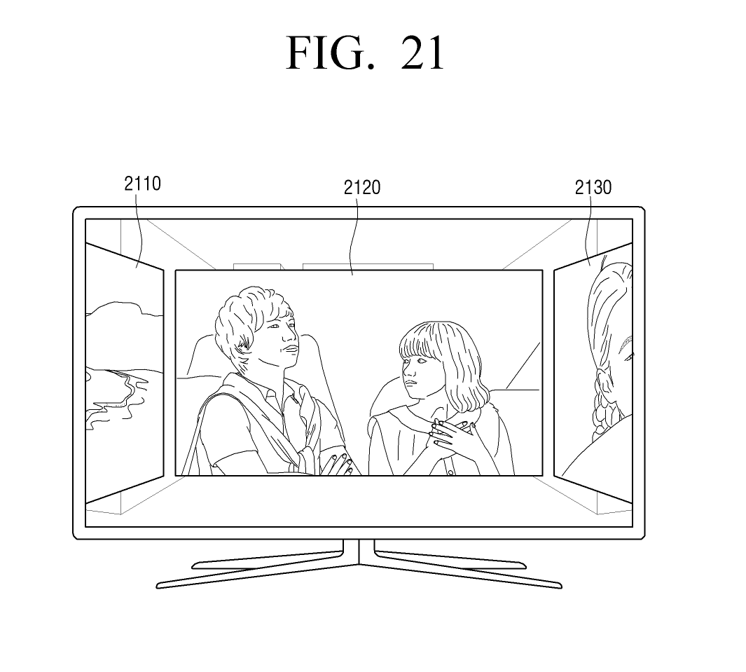

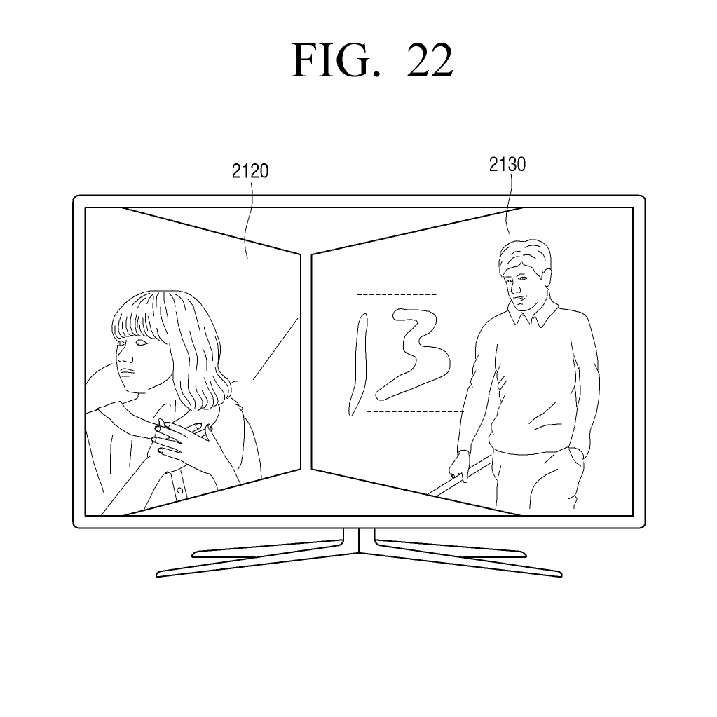

Further, in response to a predetermined user interaction being input while a highlight is displayed on one cubic GUI among the plurality of cubic GUIs, the controller 290 may control the display 230 to display the plurality of screens on the display screen, and reproduce a content which corresponds to the cubic GUI marked with a highlight on one of the plurality of screens according to the user interaction. Specifically, referring to FIG. 20, in response to the third button corresponding to the second sub-screen provided on the remote controller being selected while a highlight is displayed on the cubic GUI 555 corresponding to the “FOX CRIME” channel, the controller 290 may control the display 230 to display the main screen 2120 and the plurality of sub-screens 2110, 2130 on the display screen referring to FIG. 21, move the main screen 2120 and the plurality of sub-screens 2110, 2130 toward a left direction as referred to in FIG. 22, and make the ratio of an area that the second sub-screen cover the display screen to be the largest screen as referred to in FIG. 22. Herein, the controller 290 may control the display 230 to reproduce a program currently airing on “FOX CRIME” which corresponds to the channel marked with a highlight on the second sub-screen 2130.

Thus, as described above, a user may reproduce a content that he/she requests on one of the plurality of screens according to a user command to select a predetermined button provided on the remote controller while the plurality of objects are only displayed on the display screen.

The above exemplary embodiment describes that a user command is displayed to select a predetermined button provided on the remote controller for an example of a user interaction to select a screen which a content which corresponds to the object. However, this is one of various exemplary embodiments. A screen on which the content is displayed may be selected according to another user interaction. For example, the controller 290 may select a screen which a content which corresponds to the object is displayed by using user voices inputted through the microphone 282 of the user interface 280 (e.g., “Display it on the main” or “Display it on the center”) while a highlight is displayed on one of the plurality of objects.

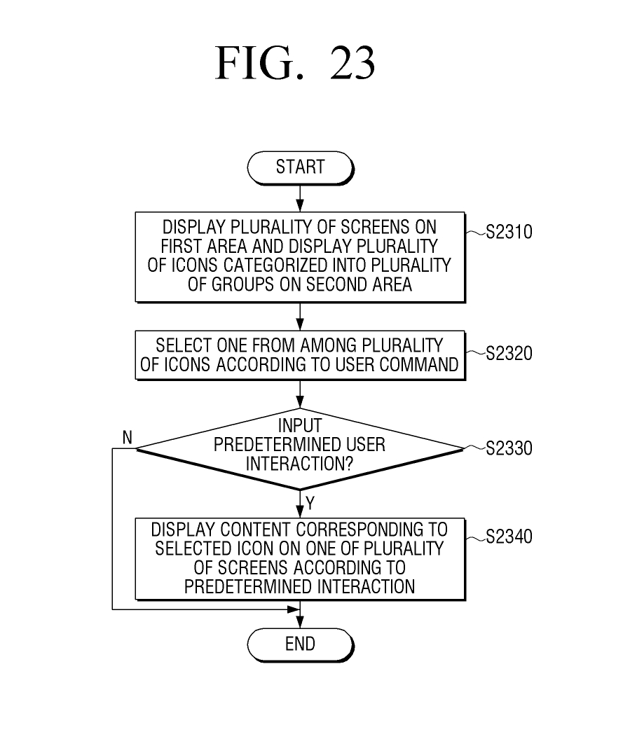

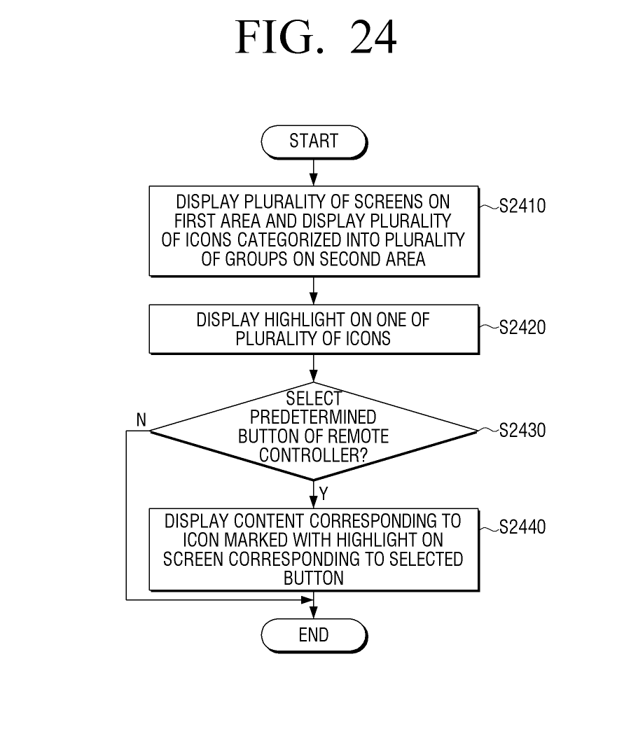

The following will describe a method of providing a UI in the display apparatus 100, according to an exemplary embodiment referred to in FIGS. 23 and 24.

FIG. 23 illustrates a method for providing UI in the display apparatus 100 to select a content to be displayed on one of the plurality of screens according to an exemplary embodiment.

First, the display apparatus 100 displays a plurality of screens on the first area of the display screen, and a plurality of objects categorized into a plurality of groups on the second area, at S2310. Specifically, the display apparatus 100 may display the main screen on a center of the upper area on the display screen, and respectively display the first sub-screen and the second sub-screen on a left side and a right side of the main screen. Further, the display apparatus 100 may display the plurality of objects in a trapezoid form to be displayed on a predetermined room according to the categorized groups on the lower area of the displays screen. Herein, the plurality of objects may be implemented to be a cubic GUI in a cubic form.

Further, the display apparatus 100 selects one object from among the plurality of objects according to a user command, at S2320. Specifically, the display apparatus 100 may place a highlight on one object among the plurality of objects, and select the object according to a user command.

The display apparatus 100 determines whether a predetermined user interaction is inputted, at S2330. The predetermined user interaction may be a user interaction to select one of the buttons which correspond to the plurality of screens provided on the remote controller. However, this is merely one of various exemplary embodiments; a screen which the content is displayed may be selected by using a user interaction to input a user voice which corresponds to the screen, the mouse, hand motion and the pointing device.

In response to a predetermined user interaction being input at S2330-Y, the display apparatus 100 displays a content which corresponds to the selected object according to the predetermined user interaction on one screen among the plurality of screens, at S2340. For example, in response to a user interaction to select one of the first to the third buttons which respectively correspond to the plurality of screens, which are provided on the remote controller, being input while a highlight is displayed on one cubic object among the plurality of cubic objects, the display apparatus 100 may reproduce a content corresponding to the object marked with a highlight on a screen which corresponds to the selected button among the plurality of screens. For another example, a user may select a screen in which a content which corresponds to the selected cubic GUI is displayed by using a voice command. Specifically, in response to a user voice of “main” being input through the microphone (not illustrated) of the user interface 120 while a highlight is displayed on the first cubic GUI which corresponds to the first broadcast channel among the plurality of cubic GUIs, the display apparatus 100 may display a broadcast content of the first broadcast channel which corresponds to the first cubic GUI on the main screen. As another example, a user may select a screen which a content corresponding to the selected cubic GUI is displayed by using the pointer controlled with the mouse, the pointing device and hand motion. Specifically, in response to the mouse being clicked and the second cubic GUI being dragged to the first sub-screen while the pointer is placed on the second cubic GUI which corresponds to the second broadcast channel among the plurality of cubic GUIs, the display apparatus 100 may display the second broadcast channel which corresponds to the second cubic GUI on the first sub-screen.

FIG. 24 illustrates a method of selecting a screen in which a content is displayed by using a predetermined button of the remote controller, according to an embodiment.

First, the display apparatus 100 displays the plurality of screens on the first area of the display screen, and the plurality of objects are categorized into a plurality of groups on the second area, at S2410. Specifically, the display apparatus 100 may display the main screen on a center of the upper area in the display screen, the first sub-screen and the second sub-screen on a left side and a right side of the main screen. Further, the display apparatus 100 may display the plurality of objects in a trapezoid form that are displayed on a predetermined room according to the categorized groups on the lower area of the display screen. Herein, the plurality of objects may be implemented to be cubic GUIs in a cubic form.

The display apparatus 100 marks a highlight on one object among the plurality of objects according to a user command, at S2420. Specifically, the display apparatus 100 may mark a highlight on one object among the plurality of objects by using a user interaction to select four-directional keys provided on the remote controller or a user interaction to rub an OJ sensor.

Further, the display apparatus 100 determines whether a predetermined button of the remote controller is selected, at S2430. Herein, predetermined buttons of the remote controller may respectively correspond to the plurality of screens displayed on the display apparatus 100, and have a uniform shape with that of the plurality of screens.

In response to a predetermined button of the remote controller being selected at S2430-Y, the display apparatus 100 displays a content which corresponds to the object marked with a highlight on a screen corresponding to the selected button, at S2440. Specifically, in response to a user interaction to select the first button being input while a highlight is displayed on the first cubic GUI corresponding to the first broadcasting channel among the plurality of cubic GUIs, the display apparatus 100 may display a broadcast content of the first broadcast channel which corresponds to the first cubic GUI on the main screen corresponding to the first button. In response to a user interaction to select the second button being input while a highlight is displayed on the second cubic GUI which corresponds to the second broadcast channel among the plurality of cubic GUIs, the display apparatus 100 may display a broadcast content of the second broadcast channel which corresponds to the second cubic GUI on the first sub-screen corresponding to the second button. In response to a user interaction to select the third button being input while a highlight is displayed on the third cubic GUI which corresponds to the first SNS content among the plurality of cubic GUIs, the display apparatus 100 may display SNS content which corresponds to the third cubic GUI on the second sub-screen corresponding to the third button.

According to the various exemplary embodiments described above, a user may more easily and intuitively display a content that he/she requests on a screen that he requests.

A program code to implement the controlling method according to the various exemplary embodiments may be stored on non-transitory computer readable recording medium. The ‘non-transitory computer readable recording medium’ refers to a medium which stores data semi-permanently and can be read by devices, rather than medium that stores data temporarily such as register, cache or memory. Specifically, the above various applications or programs may be stored and provided in non-transitory computer readable recording medium such as CD, DVD, hard disk, Blu-ray disc™, USB, memory card, or ROM.

Further, the foregoing exemplary embodiments and advantages are merely exemplary and are not to be construed as limiting the exemplary embodiments. The present teachings can be readily applied to other types of apparatuses. Also, the description of the exemplary embodiments is intended to be illustrative, and not to limit the scope of the claims.

What is claimed is:

1. A display apparatus, comprising:
a display having a display screen;
a user interface configured to detect a predetermined user interaction; and
a controller configured to display a plurality of screens on a first area of the display screen of the display and display a plurality of objects categorized into a plurality of groups on a second area of the display screen; control the display to reproduce a content which corresponds to a selected object on one of the plurality of screens in response to the predetermined user interaction being detected through the user interface while one of the plurality of objects is being selected.

2. The apparatus as claimed in claim 1, wherein the controller is further configured to display a main screen on the first area of the display screen and a first sub-screen and a second sub-screen in trapezoidal form on a left side and a right side of the main screen.

3. The apparatus as claimed in claim 2, wherein the controller is further configured to control the display to reproduce a content which corresponds to an object on one of the plurality of screens where a highlight is displayed, in response to the predetermined user interaction being detected while the highlight is displayed on one of the plurality of objects.

4. The apparatus as claimed in claim 3, further comprising a remote controller having a first button, a second button and a third button; wherein in response to the predetermined user interaction being a user interaction to select one of the first to third buttons on the remote controller which respectively corresponds to the main screen, the first sub-screen, and the second sub-screen, and
in response to a user interaction to select one of the first to the third buttons being input while the highlight is displayed on one of the plurality of objects, the controller is configured to display the object on which the highlight is displayed in order to reproduce on a screen which corresponds to the selected button a content which corresponds to the object on which the highlight is displayed.

5. The apparatus as claimed in claim 4, wherein the first to the third button on a remote controller respectively corresponds to shapes of the main screen, the first sub-screen, and the second sub-screen.

6. The apparatus as claimed in claim 1, wherein the controller is configured to display a plurality of objects which are displayed on a second area of the display screen, on different spaces according to a group,
wherein each of the plurality of objects is in a cubic form.

7. The apparatus as claimed in claim 2, wherein in response to a predetermined first user interaction being input through the user interface, the controller is configured to control the display to remove from the display screen the plurality of objects displayed on a second area of the display screen, and expand and display the plurality of screens displayed on a first area of the display screen.

8. The apparatus as claimed in claim 7, wherein the controller is configured to reduce a size of the main screen from among the plurality of screens, and display a plurality of thumbnail screens which correspond to a plurality of contents in a predetermined direction with reference to the reduced main screen, in response to a predetermined second user interaction being input through the user interface while the plurality of screens are expanded and displayed,
wherein the controller is configured to control the display to reproduce on the main screen a content which corresponds to the selected thumbnail screen in response to one of thumbnail screens which corresponds to the plurality of contents being selected.

9. The apparatus as claimed in claim 8, wherein the controller is configured to control the display to remove from the display screen the plurality of screens displayed on the first area of the display screen in response to a predetermined third user interaction being input through the user interface, and expand and display the plurality of objects displayed on the second area of the display screen.

10. The apparatus as claimed in claim 9, wherein in response to one of the first to a third buttons corresponding to the main screen, the first sub-screen, and the second sub-screen on a remote controller being respectively selected while one of the expanded plurality of objects is selected, the controller is configured to control the display to remove the expanded plurality of objects from a display screen, display the display screen on the plurality of screens, and reproduce a content on a screen, which corresponds to the selected object which corresponds to the selected button.

11. A UI providing method in a display apparatus, the method comprising:
displaying a plurality of screens on a first area of a display screen and displaying a plurality of objects categorized into a plurality of groups on a second area of the display screen; and
reproducing a content which corresponds to a selected object on one of the plurality of screens in response to a predetermined user interaction being detected through the user interface while one of the plurality of objects is selected by the user.

12. The method as claimed in claim 11, wherein the displaying comprises displaying a main screen on a first area of the display screen and a first sub-screen and a second sub-screen in a trapezoidal form on a left side and a right side of the main screen.

13. The method as claimed in claim 12, wherein the reproducing comprises reproducing a content which corresponds to an object on which a highlight is displayed on one of the plurality of screens in response to a predetermined user interaction being detected while the highlight is displayed on one of the plurality of objects.

14. The method as claimed in claim 13, wherein the reproducing comprises the predetermined user interaction being a user interaction to select one of a first to third buttons on a remote controller which respectively correspond to the main screen, the first sub-screen, and the second sub-screen, and
in response to a user interaction to select one of the first to the third buttons being input while a highlight is displayed on one of the plurality of objects, reproducing a content on a screen which corresponds to the object on which the highlight is displayed, which corresponds to the selected button.

15. The method as claimed in claim 11, wherein the first to third button on a remote controller respectively corresponds to shapes of the main screen, the first sub-screen, and the second sub-screen.

16. The method as claimed in claim 11, wherein the displaying comprises displaying a plurality of objects on a second area of the display screen in different spaces according to a group,
wherein each of the plurality of objects is in a cubic form.

17. The method as claimed in claim 12, comprising:
removing the plurality of objects displayed on a second area of the display screen from the display screen and expanding and displaying the plurality of screens displayed on a first area of the display screen in response to a predetermined first user interaction being input through the user interface.

18. The method as claimed in claim 17, comprising:
displaying a plurality of thumbnail screens which correspond to a plurality of contents in a predetermined direction with reference to a reduced main screen in response to a predetermined second user interaction being input through the user interface while the plurality of screens are expanded and displayed, reducing a size of the main screen from among the plurality of screens; and
reproducing on the main screen a content which corresponds to a selected thumbnail screen in response to one of the thumbnail screens which corresponds to the plurality of contents being selected.

19. The method as claimed in claim 12, comprising:
in response to a predetermined third user interaction being input through the user interface, removing from the display screen the plurality of screens displayed on the first area of the display screen, and expanding and displaying the plurality of objects on a second area of the display screen.

20. The method as claimed in claim 14, comprising:
in response to one of the first to third buttons corresponding to the main screen, the first sub-screen, and the second sub-screen on a remote controller respectively being selected while one of the expanded plurality of objects is selected, removing the expanded plurality of objects from a display screen, displaying the display screen on the plurality of screens, and reproducing a content which corresponds to the selected object on a screen which corresponds to the selected button.

21. A display apparatus, comprising:
a display including a display screen;
a user interface configured to detect a predetermined user interaction; and
a controller configured to display a plurality of screens on a first area of the display screen, display a main screen on the first area of the display screen and a first sub-screen and a second sub-screen, in trapezoidal form, on a left side and a right side of the main screen on the second area, and display a plurality of objects categorized into a plurality of groups on a second area of the display screen to reproduce a content which corresponds to a selected object on one of the plurality of screens in response to the predetermined user interaction being detected through the user interface while one of the plurality of objects is being selected.

22. The display apparatus of claim 21, wherein the controller is further configured to display a plurality of objects on different spaces of the display screen according to a group, wherein each of the plurality of objects is in a cubic form.

23. The display apparatus of claim 22, wherein the objects in cubic form comprise a length, width and depth that is adjusted by the controller in response to a detected user interaction.

24. The display apparatus of claim 21, wherein in response to a predetermined first user interaction being input through the user interface, the controller is configured to control the display to remove from the display screen the plurality of objects displayed on a second area of the display screen, and expand and display the plurality of screens on a first area of the display screen.

25. The display apparatus of claim 24, wherein the controller is configured to reduce a size of the main screen from among the plurality of screens, and display a plurality of thumbnail screens which correspond to a plurality of contents in a predetermined direction with reference to the reduced main screen, in response to a predetermined second user interaction being input through the user interface while the plurality of screens are expanded and displayed,
wherein the controller is configured to control the display to reproduce on the main screen a content which corresponds to the selected thumbnail screen in response to one of thumbnail screens which corresponds to the plurality of contents being selected.

26. The display apparatus of claim 21, further comprising a remote controller, wherein the predetermined user interaction is a user interaction to select one of a first to a third button on the remote controller.
